SEQUENCE LISTING (19 sequences)

SEQ ID NO: 1 - DNA, 57 bp, Artificial Sequence
  Nucleotide sequence of perfectly matched hairpin
ccgggaagctcacctaccagttcactcgagtgaactggtaggtgagcttcttttttg

SEQ ID NO: 2 - DNA, 57 bp, Artificial Sequence
  Nucleotide sequence of a mismatched hairpin
ccgggaagctcatctaccagttcactcgagtgaactggtaggtgagcttcttttttg

SEQ ID NO: 3 - DNA, 6 bp, Artificial Sequence
  Terminator sequence
tttttt

SEQ ID NO: 4 - DNA, 43 bp, Artificial Sequence
  Portion of nucleotide sequence of perfectly matched hairpin
taccagttcactcgagtgaactggtaggtgagcttcttttttg

SEQ ID NO: 5 - DNA, 14 bp, Artificial Sequence
  Portion of nucleotide sequence of perfectly matched hairpin
ccgggaagctcacc

SEQ ID NO: 6 - DNA, 43 bp, Artificial Sequence; identical to SEQ ID NO: 4
  Portion of nucleotide sequence of a mismatched hairpin

SEQ ID NO: 7 - DNA, 14 bp, Artificial Sequence
  Portion of nucleotide sequence of a mismatched hairpin
ccgggaagctcatc

SEQ ID NO: 8 - DNA, 10 bp, Artificial Sequence
  Portion of nucleotide sequence of a hairpin
atggcagtta

SEQ ID NO: 9 - DNA, 6 bp, Artificial Sequence
  Portion of nucleotide sequence of a hairpin
ctcgag

SEQ ID NO: 10 - DNA, 21 bp, Artificial Sequence
  Portion of nucleotide sequence of a hairpin
taactgccatttctaaagagg

SEQ ID NO: 11 - DNA, 6 bp, Artificial Sequence
  Portion of nucleotide sequence of a hairpin
gaattc

SEQ ID NO: 12 - DNA, 19 bp, Artificial Sequence
  Portion of nucleotide sequence of a hairpin
gtacatgaagacagccggc

SEQ ID NO: 13 - DNA, 10 bp, Artificial Sequence
  Portion of nucleotide sequence of a hairpin
ctctttagaa

SEQ ID NO: 14 - DNA, 11 bp, Artificial Sequence
  Primer S - Positions 10 and 11 thio
tttgaattcgt

SEQ ID NO: 15 - DNA, 10 bp, Artificial Sequence
  Primer AS - Positions 9 and 10 thio
tgtcttcatg

SEQ ID NO: 16 - DNA, 92 bp, Artificial Sequence
  Nucleotide sequence of a hairpin
gactactacactcgagtgtagtagtcagaatcggtggtttttgaattctagacagactagactcgtacctgcaggagccggccaccgattct

SEQ ID NO: 17 - DNA, 8 bp, Artificial Sequence
  Portion of amplified hairpin
tcctgcag

SEQ ID NO: 18 - DNA, 10 bp, Artificial Sequence
  Portion of amplified hairpin
ttttgaattc

SEQ ID NO: 19 - DNA, 58 bp, Artificial Sequence
  Nucleotide sequence of hairpin
ccggccaccgattctgactactagactcgagtctagtagtcagaatcggtggtttttg

(19) United States
(12) Patent Application Publication
(10) Pub. No.: US 2007/0141594 A1
(43) Pub. Date: Jun. 21, 2007

(54) Method of producing short hairpin library

(76) Inventors: Biao Luo, Lexington, MA (US); David Root, Brookline, MA (US); Xiaoping Yang, Brookline, MA (US); Gregory Hinkle, Plymouth, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/546,019

(22) Filed: Oct. 11, 2006

Related U.S. Application Data
(60) Provisional application No. 60/725,921, filed on Oct. 11, 2005.

(51) Int. Cl. C40B 40/08; C40B 50/06

(52) U.S. Cl. 435/6; 435/91.2

(57) ABSTRACT

Described herein is a method of cloning synthetic oligos (including in situ synthesized oligos) into an (one or more) expression vector for library (e.g., shRNA library) production. The oligos are synthesized with one portion of the first stem of the hairpin, followed by a first loop sequence, the complete second stem, a second loop sequence, and finished with the remaining portion of the first stem of the hairpin. The two portions of the first stem anneal to the second stem, juxtaposing the 5′ end close to the 3′ end of the oligo. The methods described herein selected for hairpins with perfectly base-paired stems. After annealing, a ligase is added to the annealed oligos and the base-paired hairpins are preferentially annealed, and ligated, creating closed circular oligos. The now circularized hairpins served as templates for rolling circle amplification using a polymerase with high processivity. One or more primers complementary to the two strands of the amplified double stranded circular hairpins initiate the rolling circle amplification in the presence of a polymerase. Using primers (e.g., a sense and antisense primer), the rolling circle amplification yields double stranded hairpin sequences. These can be digested (e.g., using restriction enzymes) to produce a double-stranded hairpin fragment encoding a single hairpin. The fragment can be cloned into an appropriately digested vector for a variety of uses including expression.

### RELATED APPLICATION(S)

This application claims the benefit of U.S. Provisional Application No. 60/725,921, filed on Oct. 11, 2005. The entire teachings of the above application are incorporated herein by reference.

### BACKGROUND OF THE INVENTION

shRNA libraries have been proving to be important approach for genome-wide functional genomic analysis in vertebrates. However, production of high quality shRNA libraries has been limited by the high cost of production from conventional synthesized oligos. Library production from in situ synthesized oligos offers an alternative source for low cost oligos. However, the oligos from in situ synthesis are single stranded and low in both quality and quantity. In order to produce expression constructs, amplification is required to convert the single stranded DNA into double stranded DNA and to produce enough materials for cloning. However, when regular polymerase chain reaction (PCR) is used for the amplification with amplification primer sites flanking the hairpin sequences, the strong secondary structure of the hairpins significantly inhibits amplification. During the chemical synthesis of in situ oligos, mixtures of oligos are synthesized for any given sequence. Some sequences will match the designed sequences and have perfectly base paired stem regions in the hairpins, which results in strong secondary structure. Due to the imperfection of chemical synthesis, however, incorrect bases or no bases may be incorporated at a certain rate at any give base. A large portion of synthesis products will have a deletion or mismatch mutations in the hairpin region which results in weaker secondary structure than perfectly base paired hairpins. When the mixture of perfectly base paired hairpins and imperfect hairpins with mismatched stems are subjected to regularly configured PCR reactions, hairpins with mismatches will be preferentially amplified over sequences perfectly matching designed sequences. The low representation of sequences matching design results in an inefficient production process in producing shRNA libraries.

Thus, a need exists for producing a library of sequences which encode hairpin structures, such as shRNA libraries.

### SUMMARY OF THE INVENTION

Described herein is a method of cloning synthetic oligos (including in situ synthesized oligos) into an (one or more) expression vector for library (e.g., shRNA library) production. The advantages of the methods described herein include: hairpins can be used for self-ligation under restrictive conditions resulting in enrichment of perfectly base paired sequences in the stem region of the hairpins; rolling circle amplification with a high processivity DNA polymerase with superb strand displacement activity can be used resulting in high fidelity, high efficiency amplification of hairpin sequences; and as rolling circle amplification requires much smaller primer binding sites than PCR, it is possible to synthesize unique, designed barcode sequences that are covalently linked to shRNA sequences for high throughput screening in bar-coded libraries. When all designed hairpin DNA sequences were amplified together, a strong bias favoring low GC sequences was observed, resulting in biased libraries and low production efficiency. After sequences with different GC content are amplified separately, more even clone representations are achieved, resulting in more efficient production process.

Accordingly, the present invention is directed methods of producing a library of nucleic acid sequences wherein the nucleic acid sequences encode hairpin structures. A hairpin structure generally comprises a double stranded stem with a loop at one end. The nucleic acid can be DNA, RNA (e.g., siRNA, shRNA, microRNA). Applicants have demonstrated the method herein using single stranded shDNA to produce an shRNA library, however, the skilled artisan will appreciate that the methods described herein can be used with any single stranded nucleic acid that encodes a hairpin structure to produce a library of the hairpin structures.

In one embodiment, the present invention is directed to a method of producing a short hairpin library comprising obtaining single stranded short hairpins. Each single stranded short hairpin sequence has a 5′ to 3′ order comprising: a first portion of a first strand of a stem of the short hairpin—a first loop of the short hairpin—a second strand of the stem of the short hairpin—a second loop of the short hairpin—a second portion of the first strand of the stem of the short hairpin; wherein the sequence of the first strand of the stem of the short hairpin and the sequence of the second strand of the stem of the short hairpin are complementary (and thus are capable of hybridizing to one another). The single stranded short hairpins are maintained under conditions in which each single stranded short hairpin self anneals, wherein the first strand of the stem hybridizes to the second strand of the stem thereby forming a double stranded stem, and wherein the double stranded stem is flanked by the first loop and the second loop, thereby converting each single stranded short hairpin into a circularized short hairpin which results in the formation of a plurality of circularized short hairpins. The ends of the circularized short hairpins are ligated (e.g., using a ligase such as Taq ligase) and combined with dNTPs, a polymerase (e.g., phi29) and primers, thereby producing a combination. The combination is maintained under conditions in which rolling circle amplification of the circularized short hairpins occurs and a plurality of double stranded concatemers are produced. Each double stranded concatemer comprises multiple copies of a (one, a single) short hairpin linked end to end (a sense strand of a short hairpin (one strand of one short hairpin) hybridized to the antisense strand of the hairpin (the antisense strand of the same short hairpin) linked end to end), thereby producing a short hairpin library. The method can further comprise digesting the double stranded concatemers, thereby generating individual double stranded hairpins. In addition, the method can further comprise cloning the individual double stranded hairpins into one or more vectors. The method can also comprise maintaining the one or more vectors under conditions in which the individual double stranded hairpins are expressed. Thus, in noe embodiment, the present invention provides a method of producing a short hairpin expression library.

In another embodiment, the invention is directed to a method of producing a short hairpin RNA (shRNA) library. Single stranded short hairpin DNAs (shDNAs) are obtained, wherein each single stranded short hairpin DNA (shDNA) sequence has a 5′ to 3′ order comprising: a first portion of a first strand of a stem of the shDNA—a first loop of the shDNA—a second strand of the stem of the shDNA—a second loop of the shDNA—a second portion of the first strand of the stem of the shDNA; wherein the sequence of the first strand of the stem of the shDNA and the sequence of the second strand of the stem of the shDNA are complementary (and thus capable of hybridizing to one another). The single stranded shDNAs are maintained at about 60° C. for about 10 minutes, wherein each single stranded shDNAs self anneals, whereby the first strand of the stem hybridizes to the second strand of the stem forming a double stranded stem, and wherein the double stranded stem is flanked by the first loop and the second loop, thereby converting each single stranded shDNA into a circularized shDNA which results in the formation of a plurality of circularized shDNAs. The circularized shDNAs are combined with Taq ligase at 60° C. for about 3 hours to ligate the circularized shDNAs. The circularized shDNAs are then combined with dNTPs, a phi29 DNA polymerase and one or more primers that are complementary to the sense strand of the circularized shDNAs and one or more primers that are complementary to the antisense strand of the circularized shDNAs, thereby producing a combination. The combination is maintained under conditions in which rolling circle amplification of the circularized shDNAs occurs and a plurality of double stranded concatemers are produced, wherein each double stranded concatemer comprises multiple copies of a short hairpin linked end to end (a sense strand of a shDNA hybridized to the antisense strand of the same shDNA linked end to end), thereby producing a shRNA library. The method can further comprise digesting the double stranded concatemers, thereby generating individual double stranded shDNAs. In addition, the method can further comprise cloning the individual double stranded shDNAs into one or more vectors. The method can also comprise maintaining the one or more vectors under conditions in which the individual double stranded shDNAs are expressed. Thus, in one embodiment, the present invention provides a method of producing a shRNA expression library.

In the methods of the present invention, the single stranded hairpins can be obtained by synthesizing the single stranded short hairpins on a chip and the single stranded short hairpin can be removed from the chip before the short hairpins self anneal. In addition, the first strand of the stem of the short hairpin can be the sense strand or the antisense strand of the hairpin structure. In other embodiments, the sequence of the short hairpin sequence can include (e.g., within the sequence of one or both loops) a (one or more) restriction endonuclease recognition site, a primer binding site, a barcode sequence, a label and/or a termination sequence.

In particular embodiments of the methods described herein, short hairpins having identical or substantially similar GC % are amplified in a single reaction such as on a single chip or on multiple chips in a single reaction. That is, short hairpins are identified or synthesized having identical or substantially similar GC % and are then amplified together in the methods described herein, and short hairpins having different of substantially different GC % are not present during the reaction. In one embodiment, short hairpins having a sequence comprising 8% GC are amplified together in one reaction (to the exclusion of short hairpins having a GC % that is not 8%). In another embodiment, short hairpins having a sequence comprising 8% ann 9% GC are amplified together in one reaction (to the exclusion of short hairpins having a GC % that is not 8% or 9%). When sequences with wide GC % range are amplified in the same restriction, representation of the library is skewed toward low GC % sequences. When sequences with similar GC % are amplified in the same reaction, more even representation of the sequences are achieved.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic of hairpin. Note the two portions of sense strands are contiguous for intact hairpins.

FIGS. 2A-2C illustrate PCR amplification bias against perfectly matched hairpins. FIG. 2A: Oligos (SEQ ID NOs: 1, 2, 3 and 4) were synthesized in the following configuration: primer binding site 1 (white line), restriction enzyme cloning site 1 (Agel compatible), sense strand of hairpin (yellow upper case letters and arrow), loop (green lower case letter), antisense strand of hairpin (red upper case letter and arrow), terminator (lower case tttt (SEQ ID NO: 5)), restriction enzyme cloning site 2 (EcoRI), primer binding site 2 (white line). FIG. 2B: For any intended hairpin template synthesized in situ, two classes of oligos could be synthesized: oligos that perfectly match the input sequence and could form perfectly matched stems (PCR-PM on the left); oligos that incorporate the wrong base (white letter “t” and white star “c*”) and could form mismatched hairpins (PCR-MM on the right). The ratio between these two classes of oligos is determined by the efficiency and accuracy of synthesis, as well as the length of the oligos. During PCR, both PCR-PM and PCR-MM would self-anneal and form hairpins. The strand displacement activity of the DNA polymerase used in PCR could separate the two stems during amplification. However, the secondary structure of PCR-MM would be less stable than PCR-PM, leading to the preferential amplification of mismatched sequences, and increasing the apparent mutation rate in the cloned constructs. The ratio of PCR-MM to PCR-PM in amplified materials (FIG. 2C) would be higher than that of the original oligo pools (FIG. 2A).

FIG. 3 is a graph showing distribution of mutation of PCR amplified hairpins. Hairpin sequences were PCR amplified, cloned and sequenced. The mutation rate signifies the ratio of the total number of mutations at every position to the total number of constructs whose structures were resolved. The hairpin ends had a higher mutation rate, reflecting their critical function in maintaining a strong secondary structure. Mutation rates in the stem region were also significant.

FIGS. 4A-4E show one embodiment of a method of generating shRNA libraries by error-correction, ligation-mediated rolling circle amplification of in situ synthesized oligos.

FIG. 4A: Oligos (SEQ ID NOs: 6 and 7) were designed in the following configuration: 5′-phosphate-second half of sense strand (yellow upper case letters and arrow)-loop (lower case green letters)-complete antisense strand (upper case red letters and arrow)-terminator (red tttttt)-second loop (white line including EcoRi site for cloning, primer binding sites and Agel compatible site for cloning)-first half of sense strand (upper case yellow letters and arrow). One example oligo is 5′Pho-ATGGCAGTTA (SEQ ID NO: 8) (second half of sense strand) CTCGAG (SEQ ID NO: 9) (loop) TAACTGCCATTTCTAAAGAGG (SEQ ID NO: 10) (antisense strand) TTTTTT (SEQ ID NO: 1) (terminator) GAATTC (SEQ ID NO: 11) (EcoRi site) GTACATGAAGACA GCCGGC (SEQ ID NO: 12) (NgoMIV site and first base of sense strand) CTCTTTAGAA (SEQ ID NO: 13) (first half of sense strand) 3′. The desired oligos were synthesized in situ. LM-RCA-PM represents oligos whose hairpins match perfectly to the designed oligos; LM-RCA-MM represents oligos whose hairpins have mismatches (white letter and star) to the designed oligos in the stem region.

FIG. 4B: Oligos were denatured and annealed at a restrictive temperature (60° C.). The two portions of first stem should have annealed to the second stem, juxtaposing the two ends of the oligos. At 60° C., the juxtaposition of the two ends are stabilized by perfect matched stems (LM-RCA-PM); the juxtaposition of the two ends arere destabilized by the presence of mismatches in the stem (LM-RCA-MM).

FIG. 4C: Perfectly matched hairpins are preferentially circularized by ligation at a restrictive temperature (60° C.) with Taq DNA ligase.

FIG. 4D: Rolling circle amplification was performed with Phi29 DNA polymerase in the presence of amplification primers (small white lines).

FIG. 4E: Double-stranded ized hairpin sequences were amplified by rolling circle amplification.

FIGS. 5A-5C show cloning of hairpins into an expression vector. Amplified hairpin s (FIG. 5A) were digested with the two restriction enzymes to produce a double-stranded DNA fragment (SEQ ID NOs; 9 and 10) encoding a single hairpin with AgeI and EcoRI compatible ends (FIG. 5B). The appropriately amplified and digested fragments were gel purified and cloned into an appropriately digested vector (FIG. 5C). The lentiviral vector pLKO.1 was used.

FIGS. 6A-6B show digestion of LM-RCA product.

FIG. 6A: AgeI is the 5′ cloning site of our vector pLKO.1. AgeI site or NgoMIV site or XmaI site or BspEI site can be used as the cloning enzyme site upstream from the sense strand of hairpin to keep the compatibility to AgeI site. Herein, NgoMIV or XmaI was used for library production. EcoRI site is downstream from terminator. Single enzyme digestion created a fragment of single hairpin and linker. Double digestion produced single hairpin.

FIG. 6B: Digestion of LM-RCA produced DNA by restriction enzymes.

FIG. 7 is a bar graph of the error rate of LM-RCA. Twelve chips (TRCA004 to TRCA015) of in situ synthesized oligos were processed for error-correction, ligation-mediated RCA. Four thousand to eight thousand clones from each library were sequenced. The sequencing results were analyzed to determine the percentage of clones that had mismatch sequences (error rate), the percentage of clones that had more than one hairpin insert (chimera), and the percentage of clones that had the second loop/linker as the insert (linker).

FIGS. 8A-8B show the mutation rate by position of LM-RCA from the chip TRCA032 library. Chip TRCA032 was processed by LM-RCA. The resulting library was sequenced.

FIG. 8A: The mutation rate by position was the ratio of the number of mutations at any given base to the total number of clones successfully sequenced.

FIG. 8B: Schematic of hairpin structure to illustrate the position of the bases relative to the entire hairpin.

FIG. 9. Consistent pattern of positional effect in mutation rate distribution. Five chips were processed for LM-RCA. Libraries were sequenced, and the mutation rate by position was calculated as in FIG. 7. The data from TRCA032 was plotted at bottom as a reference.

FIGS. 10A-10C are graphs showing representation bias from amplification and cloning of in situ synthesized oligos.

FIG. 10A: Representation bias from LM-RCA of in situ synthesized oligos. Multiple hairpins were designed against a set of genes. All the designed oligos were synthesized on one chip, TRCA001. LM-RCA was performed in one reaction. Clones perfectly matching input sequences were considered good/correct clones. The relationship between the number of unique clones among the correct clones and numbers of correct clones is shown. The number of unique clones that would be expected if the distribution of clones is random was also calculated and there was no bias between clones (Poisson).

FIG. 10B: Correlation between amplification bias and GC %. The distribution of oligos synthesized (blue line) and correct clones sequenced from LM-RCA of TRCA001 chip at different GC bins.

FIG. 10C: Normalized amplification efficiency of LM-RCA. The ratio of the number of correct clones sequenced to the numbers of clones ordered at different GC bins.

FIGS. 11A-11B are graphs showing amplification of oligos with similar GC % reduces amplification bias.

FIG. 11A: Reduced amplification bias when hairpins with different GC % are amplified separately. Each designed oligo batch was separated into 4 equal parts according to their GC %. Oligos with similar GC % were synthesized, amplified, and cloned in the same reaction. The relationship between the number of unique clones and the number of correct clones is shown for libraries from chips TRCA004 to TRCA015. Poisson is the simulated random distribution of clones.

FIG. 11B: Reduction in amplification bias can be extended over a wide range of sequencing depth. Libraries in A have been sequenced to a different depth. The relationship between the number of unique clones and correct clones is shown with in-depth sequencing of the libraries.

FIGS. 12A-12D are a series of graphs showing distribution of unique constructs/gene is dependent on the number of designs/gene and sequencing depth. For one set of genes, 20 designs/gene were had, the oligos were separated according to GC %, and synthesized on 4 chips. From each chip of 3918 oligos, 8000 clones were sequenced. Using this data set, different designs/gene (5, 10, 15, 20 designs/gene) and sequencing depth (A: 0.5×: 2000 sequenced clones; B: 1×: 4000 sequenced clones; C: 1.5×: 6000 sequenced clones; D: 2×: 8000 sequenced clones) were simulated, and the distribution of unique constructs/gene was determined.

FIG. 13 is a graph showing that clones from LM-RCA of in situ synthesized oligos produced good yields of DNA and virus.

FIG. 14 is a schematic showing rolling circle amplification (RCA) from in situ oligos.

FIG. 15 is a workflow chart of one embodiment of the methods described herein.

FIG. 16 is a schematic showing RCA of in situ synthesized oligos.

FIG. 17 is a schematic of RCA of in situ synthesized oligos.

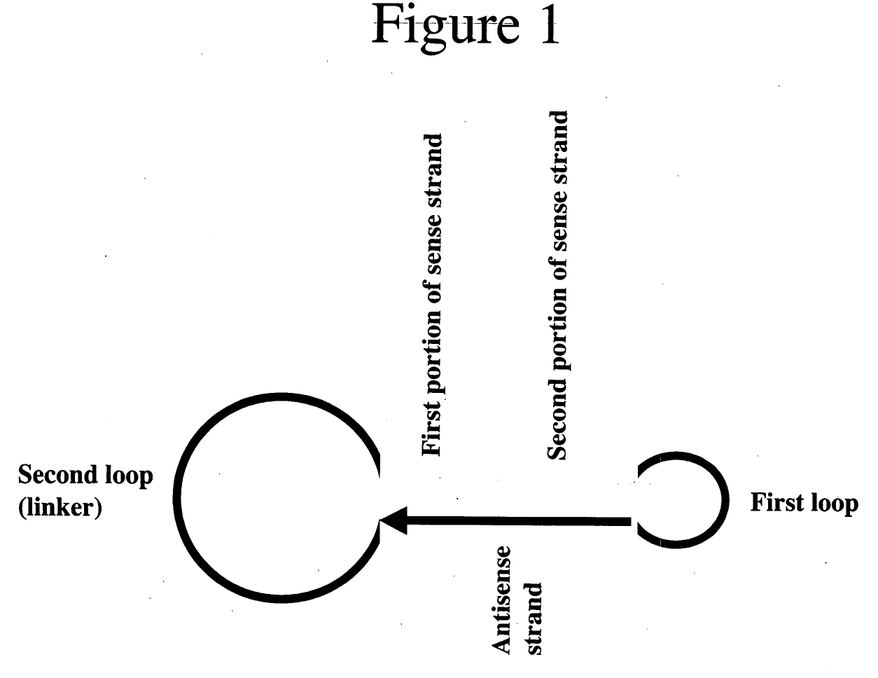

### DETAILED DESCRIPTION OF THE INVENTION

RNA-mediated interference (RNAi), a mechanism that functions by destroying the message RNA (mRNA) of a targeted gene, is employed by many eukaryotes to defend against invading viral genomes or to clear a cell of aberrant transcription products. Cellular uptake of long double stranded RNA (dsRNA), which corresponds to a duplex of a sense RNA sequence and an antisense RNA sequence, induces RNAi in lower eukaryotes. RNAi involves the degradation of target mRNA whose sequence is complementary to one of the strands of the long dsRNA. In mammalian cells, long dsRNA induce an interferon response, which results in a general inhibition of protein synthesis. Short dsRNA (19-23 bases in length), however, cause sequence-specific inhibition of target mRNA without inducing the interferon response in mammalian cells. This short dsRNA is referred to as small interfering RNA (siRNA).

siRNA mammalian expression plasmids can include an RNA promoter (e.g., an RNA polymerase III promoter) placed upstream of a DNA sequence that when transcribed folds back on itself to form a short hairpin RNA (shRNA) which comprises a “stem” region and a “loop” region. For example, the DNA sequence can be designed with the first 19-29 nucleotides being the sequence used in the siRNA for the target gene. Immediately 3′ to these bases are about 2-50 random bases that do not hybridize, or do not hybridize to any significant extent, and thus serve as a “loop”. Immediately downstream of the loop is the antisense sequence of the first 19-29 nucleotides. The transcription of the hairpin can be terminated using, for example, a poly dT sequence downstream (immediately downstream) of the siRNA target antisense sequence. Additional nucleotides can be added to both the 5′ and 3′ ends for cloning. When the DNA sequence is transcribed, the transcript of the siRNA expression plasmid is able to fold onto itself as the sense and antisense regions are able to base-pair and form a “stem”. The “loop” region allows for the shRNA to form. Cellular ribonucleases can remove the “loop” thus forming a 19-29 nucleotide siRNA molecule or duplex that targets a gene.

Described herein are methods of producing a library of nucleic acid sequences wherein the nucleic acid sequences encode hairpin structures. The nucleic acid can be DNA, RNA (e.g., siRNA, shRNA, microRNA). Applicants have demonstrated the method herein using single stranded hairpin DNA to produce an shRNA library, however, the skilled artisan will appreciate that the methods described herein can be used with any single stranded nucleic acid that encodes a hairpin structure to produce a library of the hairpin structures.

In one embodiment, the invention is directed to methods of producing a shRNA library. Production of shRNA libraries from individually synthesized oligonucleotides, also referred to herein as “oligos”, is inefficient. Initially, in situ synthesized oligos to make shRNA libraries was attempted. During chemical synthesis of in situ oligos, mixture of oligos are synthesized for any given sequence. Due to the imperfections of chemical synthesis, incorrect bases may be incorporated or bases may be missing at certain rate at any given base. When hairpin sequences are synthesized, correctly synthesized sequences will have perfectly matched stems of hairpins, resulting in strong secondary structure that is difficult for DNA polymerase to amplify. On the other hand, some incorrectly synthesized sequences will create mismatches in the hairpin region. The inherently weaker secondary structures of the imperfect hairpins make them more amenable to amplification by PCR. Using a population of both perfectly base-paired hairpin and mutated hairpin containing mismatched bases, standard PCR amplification will preferentially amplify the mutated hairpins, resulting in apparent mutation rate that is higher than the intrinsic mutation rate during synthesis.

There are also size limitations of in situ synthesized oligos. The combination of two stems of hairpins, loop, terminator and restriction enzyme sites can be about 66 bases. The amplification primers can be 12 oligomers (“mers”) on each side. The amplification primers are also very close to the hairpins. As a comparison, convention PCR primers are usually at least 20 bases long. The small size of primer and their proximity to hairpin contribute to inefficient and inconsistent PCR amplification.

To overcome the difficulties encountered in amplification, an error correction, ligation mediated rolling circle amplification method was developed for high throughput production of shRNA libraries. In the methods described herein, the hairpins' intrinsic tendency to self-anneal is transformed from a disadvantage in PCR amplification into an advantage in ligation mediated rolling circle amplification. By employing the new method, the mutation rate was reduced, production efficiency was increased, and a robust and consistent production platform for high throughput production of shRNA libraries was engineered.

In the methods of the present invention, instead of synthesizing the stem-loop-stem of hairpins as an uninterrupted sequence, the oligo was synthesized with one portion (contiguous portion) of the first stem, followed by a first loop (e.g., the loop of the hairpin structure), the complete (full length; contiguous) second stem, a second loop (e.g., a loop for circularizing the hairpin structure), and finished with the remaining portion (contiguous portion) of the first stem. As shown herein, the oligos can be denatured and self-annealed under restrictive conditions. The two portions of the first stem anneal to the second stem, juxtaposing the 5′ end close to the 3′ end of the oligo. The methods described herein select for hairpins with perfectly base-paired stems. Use of the methods described herein prevent or disfavor (partially, completely) mismatches in the hairpin region created by synthesis errors on either the first or second stem of the hairpin structure. Mismatches that are closer to the ends of oligos, which are generally positioned in the central region of the stems, have greater effect in destabilizing the hairpin formation. After annealing, a ligase is added to the annealed oligos and the base-paired hairpins (e.g., substantially or perfectly base-paired hairpins) are preferentially annealed, and ligated, creating closed circular DNA. The now circularized hairpin DNA can serve as templates for rolling circle amplification using a DNA polymerase with high processivity (e.g., Phi29 DNA polymerase). One or more primers complementary to the two strands of the amplified double stranded circular DNA initiated the rolling circle amplification in the presence of Phi29 polymerase. Using at least two primers (e.g., a sense and antisense primer), the rolling circle amplification yields double stranded strings of circularized hairpin sequences. These can be subjected to digestion (e.g., using restriction enzymes) to produce a double-stranded DNA fragment encoding a single hairpin. The fragment can be cloned into an appropriately digested vector for shRNA expression.

Obtaining Oligonucleotides (Oligos)

In the methods of the present invention a single stranded short hairpin DNAs (shDNAs) are obtained, wherein each single stranded short hairpin DNA (shDNA) sequence has a 5′ to 3′ order comprising: a first portion of a first strand of a stem of the shDNA—a first loop of the shDNA—a second strand of the stem of the shDNA—a second loop of the shDNA—a second portion of the first strand of the stem of the shDNA, wherein the sequence of the first strand of the stem of the shDNA and the sequence of the second strand of the stem of the shDNA are complementary. In one embodiment, the 5′ end of the oligonucleotides can be phosphorylated (e.g., during synthesis or by kinase after synthesis).

The single stranded hairpins of the present invention can be synthesized using known techniques (e.g., synthesized on an oligo synthesizer or on a chip) or obtained from commercial sources such as Atactic Technologies, Agilent, Nimblegen, CombiMatrix.

The first strand of the stem can be either the sense strand or the antisense strand of the stem. Thus, when the first strand of the stem is the sense strand, then the second strand of the stem is the antisense strand. Alternatively, when the first strand of the stem is the antisense strand, then the second strand of the stem is the sense strand. The sequence of the sense strand and the antisense strand of the stem can be substantially complementary or completely complementary (perfectly matched) to one another. The stem can comprise any suitable number of nucleotides. For example, the stem region can comprise from about 5 to about 70 about nucleotides, about 5 to about 50 nucleotides, about 7 to about 40 nucleotides, about 10 to about 30 nucleotides and about 12 to about 29 nucleotides, about 25 to about 28 nucleotides, and about 19 to about 22 nucleotides. The sense strand and the antisense strand of the stem can comprise the same or substantially the same number of nucleotides.

As shown herein, instead of synthesizing the stem-loop-stem hairpin as an uninterrupted sequence, the oligo was synthesized to produce a single stranded sequence having the following order: one portion (contiguous portion) of the first stem, followed by a first loop (e.g., the loop of the hairpin structure), the complete second stem, a second loop (e.g., to circularize the hairpin structure), and finished with the remaining (second) portion (contiguous portion) of the first stem. The portions (the first portion and the second portion) of the first stem can be any fragment of the first strand. In a particular embodiment, one or both portions are contiguous portions of the first strand. For example, the first or second portion can be about a quarter, about a third, about a half, about two thirds, or about three quarters of the length of the first strand of the stem. In a particular embodiment, the first and second portions of the first strand of the stem are approximately equal halves of the first strand of the stem. In another embodiment, the first and second portions of the first strand of the stem are exactly equal halves of the first strand of the stem.

The embodiment described above juxtaposes the 5′ and 3′ ends of oligos which can be ligated directly by DNA ligase. An alternative design is to leave a gap between the 5′ and 3′ ends after annealing. Specifically, 5′ end of oligo is the end of first stem; 3′ end of oligo is the beginning of first stem; but the middle portion of first strand is not chemically synthesized. Upon self-annealing, 5′ and 3′ ends anneal to the second strand; the gap is filled in with primer extension by DNA polymerase and with 3′ end of oligo as primer. The circle can be closed by ligase. With this variation of the technology, longer hairpins can be generated. Primer extension has more accuracy, so hairpins with a perfect match can be generated.

In particular embodiments, target sequences can be selected from gene sequences for their knockdown potential and specificity. For example, when constructs against 1567 genes were produced, 10 target sequences for every gene were selected, resulting in 15670 total shRNA targets. The GC % is calculated for every sequence. Sequences are separated into 4 equal batches of 3918 per batch with sequences with similar (e.g., 8% to 10%), substantially similar (e.g., 8% to 9%), or identical (e.g., 8%) GC % grouped together. Based on any given chosen shRNA target sequence, oligo can be designed according to the following configuration: 5′ Phospho-second half of sense strand of hairpin-loop-antisense strand-pol III terminator (4 to 6 Ts)-restriction enzyme I (optional)-unique barcode (optional)-restriction enzyme II (optional)-restriction enzyme III (optional)-first half of sense strand-end. An alternative design without a barcode comprises: 5′ Phospho-second half of sense strand of hairpin-loop-antisense strand-pol III terminator-restriction enzyme I (optional)-dedicated primer I for RCA-dedicated primer II for RCA-restriction enzyme III (optional)-first half of sense strand-end. Another alternative is to start the synthesis from antisense strand: second half of antisense strand-terminator-restriction enzyme I (optional)-unique barcode (optional)-restriction enzyme II (optional)-restriction enzyme III (optional)-sense strand-loop-first half of antisense strand. The complementary strand of any above configurations can also be synthesized. The oligos can be 5′ phosphorylated during synthesis or by kinase post synthesis.

Oligos can be obtained from commercial sources (e.g., Atactic Technologies, Agilent, Nimblegen, CombiMartrix), particularly long oligos, produced in highly multiplexed fashion (in situ synthesis).

Oligonucleotide Self-Annealing and Ligation

The single stranded shDNA sequences are maintained under conditions in which each single stranded shDNA self anneals. As used herein, each single stranded shDNA self anneals when the first strand of the stem of an shDNA hybridizes to the second strand of the stem of the same shDNA, thereby forming a double stranded stem. That is, due to the complementarity between the sequence of the first strand of the stem and the sequence of the second strand of the stem, base pairing occurs. The base pairing can be either a conventional (standard) Watson-Crick base pairing or a non-conventional (non-standard) non-Watson-Crick base pairing, for example, a Hoogstein base pair or bidentate base pair.

As used herein, “Watson-Crick base pair” refers to a pair of hydrogen-bonded bases on opposite antiparallel strands of a nucleic acid. The rules of base pairing, which were first elaborated by Watson and Crick, are well known to those of skill in the art. For example, these rules require that adenine (A) pairs with thymine (T) or uracil (U), and guanine (G) pairs with cytosine (C), with the complementary strands anti-parallel to one another. As used herein, the term “Watson-Crick base pair” encompasses not only the standard AT, AU or GC base pairs, but also base pairs formed between non-standard or modified bases of nucleotide analogs capable of hydrogen bonding to a standard base or to another complementary non-standard base. One example of such non-standard Watson-Crick base pairing is the base pairing which involves the nucleotide analog inosine, wherein its hypoxanthine base forms two hydrogen bonds with adenine, cytosine or uracil of other nucleotides.

Any suitable conditions under which each single stranded shDNA self anneals can be used in the methods of the present invention. A person of skill in the art will recognize that there are a variety of suitable conditions for self annealing complementary sequences. In one embodiment, the conditions comprise maintaining the single stranded shDNAs at a temperature of about 60° C. for about 10 minutes.

In particular embodiments, prior to the self annealing step, the single stranded shDNAs can be denatured under appropriate conditions. A person of skill in the art will also recognize that there are a variety of suitable denaturing conditions that can be used in the methods of the present invention. In one embodiment, the conditions comprise maintaining the single stranded shRNAs at a temperature of about 95° C. for about 5 minutes.

In the methods of the present invention, self annealing the shDNAs converts the single stranded shDNAs into circularized shDNAs, wherein the first strand of the stem hybridizes to the second strand of the stem thereby forming a double stranded stem, and the double stranded stem is flanked by a first loop and a second loop.

The loops are generally unpaired regions that do not hybridize, or do not hybridize to any significant extent, and thus form a “loop” flanking the double stranded stem (paired region; hybridized region). One of the loops functions as the loop region of the hairpin structure, and the other loop functions to circularize the hairpin structure. The loop which functions to circularize a short hairpin is not considered a loop of a hairpin structure. The length and sequence of the first and second loops can be the same or different as long as each loop is of a sequence and length that is compatible with (can function in) rolling circle amplification. In a particular embodiment, the length of the first and/or second loop is from about 2 to about 70 nucleotides, about 2 to about 50 nucleotides in length; about 4 nucleotides to at least about 40 nucleotides in length; about 6 to about 30 nucleotides; from about 8 to about 25 nucleotides; from about 10 to about 20 nucleotides; from about 12 to about 18 nucleotides and from about 14 to about 16 nucleotides. One or both loops can further comprise one or more restriction endonuclease recognition sites, termination sequences, primer binding sites, labels (tags), and/or barcode sequences.

After the annealing step, the shDNAs can be maintained under conditions in which the ends of the circularized shDNAs are ligated. A person of skill in the art will recognize that there are a variety of suitable conditions that can be used to ligate the circularized shDNAs. In one embodiment, the conditions comprise combining the circularized shDNAs with a ligase, such as Taq ligase, and maintaining the combination at a temperature of about 60° C. for about 3 hours. Other thermostable or non-thermostable ligases can be used. For error correction ligation, thermostable ligases are preferred. In one embodiment, the ligated products (e.g., ligated circularized shDNAs) can be purified (partially purified, substantially purified) to remove impurities or unwanted reaction products (e.g to remove the ligase thereby minimizing ligation of unwanted products in subsequent steps).

In particular embodiments, 5′ phosphorylated oligos are denatured and self annealed and ligated under restrictive conditions. For example, the conditions can comprise denaturing at about 80° C. to about 95° C., annealing and ligating with Taq DNA between about 16° C. to about 80° C.; or about 45° C. to about 72° C. Under high temperature annealing and ligation conditions, sequences with perfectly base paired sequences near the ligation site (the site where the first portion of the first strand and the second portion of the first strand anneal to the second strand juxtaposing the 5′ and 3′ ends of the oligos) can be efficiently ligated, resulting in enrichment of sequences with perfectly base paired hairpins. If desired, the ligation products can be purified immediately after ligation to minimize the ligation of unwanted products.

Rolling Circle Amplification (RCA)

After ligation, the circularized shDNAs are combined with dNTPs, a polymerase and primers and maintained under conditions in which rolling circle amplification (RCA) occurs.

According to the methods of the invention, RCA is carried out in the presence of one or more nucleoside triphosphates. The nucleoside triphosphates can be standard deoxynucleoside triphosphates (also referred to herein as dNTPs (e.g., dATP, dCTP, dGTP, dTTP, dUTP) and pppNs (e.g., pppA, pppC, pppG, pppT)), modified dNTPs (e.g., thiol-deoxynucleoside triphosphates (e.g., 3′ and 5′ thiol-nucleoside triphosphates (also referred to herein as sdNTPs (e.g., sdATP, sdCTP, sdGTP, sdTTP, sdUTP) and dNsTPs (e.g., dAsTP, dCsTP, dGsTP, dTsTP, dUsTP)) or a mixture thereof. In addition, one or more of the dNTP can be labeled as will be understood by the person of skill in the art. In a particular embodiment, each of the four dNTPs comprises a distinct label, which is not present on any other nucleotide in the mixture. For example, the label can be present on the 5 carbon position of a pyrimidine base or on the 7 carbon deaza position of a purine base. A person of skill in the art will recognize that a polynucleotide sequence can be determined, according to the methods of the present invention, by performing a single reaction that utilizes a mixture of four conventional nucleoside triphosphates and four modified dNTPs, wherein each of the four modified dNTPs comprises a distinct label that is not present on any other nucleotide in the mixture.

As used herein, the term “primer” refers to an oligonucleotide, which is complementary to the template oligonucleotide (polynucleotide) sequence (e.g., the circularized shDNAs) and is capable of acting as a point for the initiation of synthesis of a primer extension product. In one embodiment, the primer is complementary to the sense strand of a oligonucleotide sequence and acts as a point of initiation for synthesis of an antisense strand extension product. In another embodiment, the primer is complementary to the antisense strand of a oligonucleotide sequence and acts as a point of initiation for synthesis of a sense strand extension product. In a particular embodiment, a primer that is complementary to the sense strand of the oligonucleotide sequence and a primer that is complementary to the antisense strand of the oligonucleotide sequence is used in the methods of the present invention. The primer may occur naturally, as in a purified restriction digest, or be produced synthetically. The appropriate length of a primer depends on the intended use of the primer, but typically ranges from about 2 to about 20; from about 3 to about 18; from about 4 to about 16; from about 5 to about 14; from about 6 to about 12; and from about 7 to about 10 nucleotides. In particular embodiments, the length of the primer is about 10 or about 11 nucleotides. A primer need not reflect the exact sequence of the template but must be sufficiently complementary to hybridize with a template for primer elongation to occur, i.e., the primer is sufficiently complementary to the template polynucleotide sequence such that the primer will anneal to the template under conditions that permit primer extension and strand displacement. As used herein, the phrase “conditions that permit primer extension and strand displacement” refers to those conditions, e.g., salt concentration (metallic and non-metallic salts), pH, temperature, and necessary cofactor concentration (e.g., DMSO), among others, under which a given polymerase enzyme catalyzes the extension of an annealed primer. Conditions for the primer extension and strand displacement activity of a wide range of polymerase enzymes are known in the art.

Extension of a primer can be accomplished using a nucleic acid polymerase which is capable of enzymatically-incorporating both standard (dNTPs) and modified thiol deoxynucleotides (sdNTPs) into a growing nucleic acid strand during RCA. As used herein, the phrase “nucleic acid polymerase enzyme” refers to an enzyme (e.g., naturally-occurring, recombinant, synthetic) that catalyzes the template-dependent polymerization of nucleoside triphosphates to form primer extension products that are complementary to one of the nucleic acid strands of the template nucleic acid sequence during RCA. Numerous nucleic acid polymerases are known in the art and are commercially available. Generally, nucleic acid polymerases that have strong strand displacement activity, e.g., they separate the double stranded DNA while they are performing primer extension, are particularly useful for the methods of the present invention.

Suitable polymerases for the methods of the present invention include any polymerase known in the art to be useful for recognizing and incorporating standard deoxynucleotides. Examples of such polymerases are Phi29, Bst DNA polymerase, Tth DNA polymerase, Pfu DNA polymerase and Vent DNA polymerase. Examples of RNA polymerases include, but are not limited to, E. coli RNA polymerase, T7 RNA polymerase and T3 RNA polymerases.

In particular embodiments, conditions permitting the extension of a nucleic acid primer by Phi29 polymerase during RCA include the following: Ligation products are mixed with amplification primers. The amplification primers can be a pair of sense and antisense primers that anneal to sequences common to all or a subgroup of the in situ synthesized oligos. The common sequences can be either dedicated primer binding sites or common restrictive enzyme sites or common terminator sites. The last 2 bases of the primers can have phosphothio linkage to minimize the effect of exonuclease activity of amplification polymerase. In a particular embodiment, the ligation and primer mix is heated to about 95° C. for about 5 minutes, cooled to an appropriate temperature (e.g., 30° C. for phi29 polymerase), the polymerase is added and the rolling circle amplification starts. After a certain period of time (robust amplification can occur from about 15 minutes to about 16 hours of incubation with phi29 polymerase), the reaction is terminated. For phi29 polymerase, about 10 minutes at about 65° C. can inactivate the enzyme.

Restriction Digestion of RCA Products

The RCA products are digested with appropriate combination of restriction enzymes to create compatible sites to be cloned into expression vector. To clone into LKO. 1 vector, EcoRI and enzymes sharing overhang with AgeI can be used for digestion. The digested products are dephosphorylated and gel purified with agarose or acrylamide gels.

Ligation into Vector

As used herein, a “vector” is, for example, a plasmid, a virus, a phage or a phagemid, as will be understood by one of skill in the art. A vector as is understood by one of skill in the art to contain an origin of replication (“ori”) for DNA replication in a host organism (for example, E. coli). In addition, the vector can include a promoter such as a Pol III promoter, a Pol II promoter and/or a Pol I promoter. The vector can also comprise termination sequences such as a poly T sequence (TTTTTT (SEQ ID NO: 5)) or a poly A signal. As used herein, “cloning” is the propagation of a nucleic acid sequence in a vector in a viable host cell, such as E. coli, as will be understood by one of skill in the art.

RCA products (e.g., purified, substantially purified) can be ligated into vector digested using appropriate restriction enzymes (e.g., EcoRI and AgeI for LKO. 1).

Sequence Validation

The methods of the present invention can further comprise validation of the sequences. For example, the ligation products can be transformed into bacteria (e.g., E. coli). Individual colonies are picked and sequenced. The sequencing results are analyzed. The mutation rate can be calculated. The clones matching input sequences are selected and rearrayed.

Gene Recycle

In further embodiments, a certain number of constructs for any given constructs are desired. If the sequence validated clones are less than the desired number, more constructs targeting these genes can be entered into the next cycle of production for additional clones.

As one of skill in the art will appreciate the oligos used in the methods of the present invention can comprise additional components, for example, to aid in the method of producing the library, to monitor the formation of product in one or more of the steps of the methods, or to make use of the library produced by the methods described herein. For example, barcode sequences, primer binding sites, restriction endonuclease recognition sites, termination sequence or signal (e.g., TTTTTT (SEQ ID NO: 5); poly A signal) and/or labels (fluorescent tags) can be included in the oligonucleotide sequences. One of skill in the art will also be able to determine the regions of the oligos into which one or more of these additional components can be inserted (e.g., within, before, or after a strand of the stem; within, before or after a loop sequence), which will depend, in part, on the function the additional component will serve.

In addition, the methods of producing a library described herein can comprise additional steps. In one embodiment, the method can further comprise contacting the circularized shRNAs with a topoisomerase, for example, during RCA, in order to minimize constraint or tension of the double stranded shRNAs generated during amplification. In another embodiment, the methods of the present invention can comprise one or more purification steps. For example, after the ligation step but before the RCA step, the ligation products can be purified to remove the ligase so as to minimize the ligation of unwanted products. In addition, the methods of the present invention can comprise one or more wash steps (e.g., washing the products with buffer) to remove impurities.

One of skill in the art will also appreciate that one or more of the steps of the methods described herein can be performed sequentially or simultaneously.

The present invention is also directed to a kit comprising one or more components for carrying out the methods described herein. In one embodiment the kit comprises a ligase suitable for ligation of circularized, single stranded oligos which encode a hairpin structure, dNTPs, a polymerase suitable for RCA, a vector for cloning and/or instructions for the method of producing the library. The kit can further comprise a variety of buffers suitable for use in the methods of the present invention.

Exemplification

Error correction, ligation mediated rolling circle amplification of in situ synthesized oligos for high throughput, high fidelity production of short hairpin RNA expression libraries

Example Protocol

High temperature, error correction, hot-start ligation with Taq DNA ligase:

Note: Protocol is for the processing of 2 chips.

Material:
Five 200 ul PCR tubes
2 tubes of Oligo mix (2 chips)
dH2O water
10× Taq ligase buffer
Taq DNA ligase (NEB)

1. Label PCR tubes according to chip number, following A and B version. Label the fifth tube as ‘Blank Control’

2. In 200 ul PCR tubes add the following:
34 ul dH2O
1.5 ul from fresh tube of 10× Taq ligase buffer
12.5 ul Oligo Mix
Note: For the ‘Blank Control’ tube, add 12.5 ul of dH2O instead of Oligo Mix and process as normal.

3. Place all tubes on PCR machine and run:
95 C for 5 minutes
60 C for at least 10 minutes

4. With tubes on PCR, add the following:
3.5 ul 10× Taq ligase buffer
3 ul Taq DNA ligase (NEB)

5. Mix by pippeting 20 ul up and down 3 times

6. Incubate at 60 C for 3 hours

7. Remove tubes and put on ice, process to next step.

Rolling Circle Amplification with phi29 DNA Polymerase:

8. Put ligation A and ligation B (˜50 ul each) on ice, add the following:
14 ul dH2O
5 ul 10× phi29 buffer (NEB)
16 ul 2.5 mM dNTP
5 ul 50 uM Primer S
5 ul 50 uM Primer AS

9. Mix by pippeting up and down 3 times

10. Place on PCR machine and run:
95° C. for 5 minutes
4° C. for 5 minutes
30° C. forever

11. With tubes on PCR machine, add 4 ul phi29 DNA polymerase

12. Mix by pippeting up and down 3 times

13. Split each tube of 100 ul into 2 tubes of 50 ul each (label A2, B2)
Note: For the Blank, split and keep 1 tube on PCR machine.

14. Remove 2 ul from A2, B2 and Blank Control reaction and add to a tube on ice for control pico green reading.

Monitoring Progression of Amplification:

15. Starting at 30 minutes after the start of amplification, monitor the concentration of double stranded DNA during amplification from ligation A and ligation B of low GC Oligo Mix (lowest number of TRCA from each lot) reaction.

Picogreen Dilution and Measurement:

16. Picogreen dilution: For 1.2 ml of picogreen, add 180 ml of buffer TE (3× dilution).

17. To the black picogreen 96 well plate, add 120 ul 3× picogreen solutions.

| | 30 min | 45 min | 1 hr | 1 hr 15′ | 1 hr 30′ | 2 hr | | | | | | |
|---|---|---|---|---|---|---|---|---|---|---|---|---|
| | 1 | 2 | 3 | 4 | 5 | 6 | 7 | 8 | 9 | 10 | 11 | 12 |
| A | Amp. A | → | → | → | → | → | → | → | → | → | → | → |
| B | Amp. B | → | → | → | → | → | → | → | → | → | → | → |
| C | | | | | | | | | | | | |
| D | | | | | | | | | | | | |
| E | Blank | → | → | → | → | → | → | → | → | → | → | → |
| F | | | | | | | | | | | | |
| G | | | | | | | | | | | | |
| H | CTR A | CTR B | | | BLANK | | | | | | | |

18. Add 2 ul of control amplification DNA to H1 to H4. Add 2 ul of DNA amplification to wells as above.

19. Mix on plate mixer around 1 minute.

20. Read on picogreen reader with RNAi 3× picogreen protocol
Start KC4
Choose RNAi 3× picogreen protocol from ‘Protocol menu’
Choose new plate
Load plate and read
Export
At the bottom of the spreadsheet, find the column “ng/ul in original sample.” The value for No sample addition should be less than Sng/ul. Repeat the pico green every 15 minutes for ligation A and ligation B until the concentration reaches close to 150 ng/ul.

21. Once the concentration teaches close to 150 ng/ul, terminate the reaction by heating at 65° C. for 20 minutes, pool duplicated tubes from each reaction to obtain about 100 ul each A and B amplification.

Restriction Digestions:

Perform NgoM4/EcoRI and XmaI/EcoRI digestions for each amplification (A, B & Blank) by prepare 5 tubes per chip (1.5 ml) as following:

| Tubes | 1A | 2A | 3A | 1B | 2B |
|---|---|---|---|---|---|
| Enzyme | NgoMIV/EcoRI | XmaI/EcoRI | EcoRI | NgoMIV/EcoRI | XmaI/EcoRI |
| Enzyme | NgoMIV/EcoRI | XmaI/EcoRI | BLANK Control | NgoMIV/EcoRI | XmaI/EcoRI |

For 10 ul amplified DNA

| NgoM4/EcoRI digestion: | XmaI/EcoRI digestion: | EcoRI digestion: | Blank Control |
|---|---|---|---|
| 31.5 ul dH2O | 31.5 ul dH2O | 31.5 ul dH2O | 31.5 ul dH2O |
| 5 ul 10× NEB buffer 4 | 5 ul 10× NEB buffer 4 | 5 ul 10× NEB buffer 4 | 5 ul 10× NEB buffer 4 |
| 0.5 ul 100× BSA | 0.5 ul 100× BSA | 0.5 ul 100× BSA | 0.5 ul 100× BSA |
| 1.5 ul NgoM4 | 1.5 ul XmaI | 1.5 ul NgoM4 | 1.5 ul NgoM4 |
| 1.5 ul EcoRI | 1.5 ul EcoRI | 1.5 ul EcoRI | 1.5 ul EcoRI |
| 10 ul amplified DNA | 10 ul amplified DNA | 10 ul amplified DNA | 10 ul Blank Control |

Mix and incubate at 37° C. for 4 hours or overnight

Shrimp Alkaline Phosphatase (SAP) Treatment:

| 50 ul amplified DNA | 10 ul amplified DNA |
|---|---|
| Add 10 ul 10× SAP buffer | Add 1.5 ul 10× SAP buffer |
| Add 5 ul SAP and mix | Add 1 ul SAP and mix |

Place tubes in water bath at 37° C. for 1 hour

Purification and Size Selection by PAGE (TAE or TBE):

Prepare PAGE gel:
a. Take gel out of the cold room and aligned it with the template
b. Pour 1× TAE buffer into gel box.
c. Add 10 ul of 6× DNA loading dye to digestion DNA tubes
d. Split one DNA tube into two and load into 2 gel well.
e. Run at 100 voltage for 2 hours 15 minutes or until the yellow dye reaches the bottom.

Prepare Ethedium Bromide and tubes:
a. In a tray mix 200 ml gel running 1× TAE buffer +100 ul of Ethedium Bromide
b. Use a needle and punch a hole into 500 ul tube. Place the 500 ul tube inside a 1.5 ml screw cap tube.

Ply open and fragment the gel:
a. Tear off the plastic and get the gel out.
b. Soak the gel in Ethedium Bromide mix for 5 minutes.
c. Place the stained gel on a piece of saran wrap on UV box with long wave (365 nm) light on.
d. Cut out the lower band (˜60 bp. Cut only NgoM4 and XmaI) and put into a needle pieced 500 ul tube inside a 1.5 ml screw cap tube.
e. Once all the bands are isolated, centrifuge to shred the gel into small fragments
f. Add 100 ul 1× NEB buffer 2 to the gel fragments
g. Soak overnight at 4 C, preferably with some mixing

Ligation & Transformation

Ligation

Materials:
2 PCR plates
VWR water
H11 tube (positive control)
Amplified DNA
Vector
T4 ligase buffer
T4 DNA ligase

PCR plate orientation for per chip:

| | | 1 | 2 | 3 | 4 | 5 | 6 | 7 | 8 | 9 | 10 | 11 | 12 |
|---|---|---|---|---|---|---|---|---|---|---|---|---|---|
| NgoIV | A | 2 ul A | 2 ul B | 20 ul A | 20 ul B | − | + | TR | | | | | |
| XmaI | B | 2 ul A | 2 ul B | 20 ul A | 20 ul B | (2 ul)BLANK | | | | | | | |
| | C | | | | | | | | | | | | |
| | D | | | | | | | | | | | | |
| | E | | | | | | | | | | | | |
| | F | | | | | | | | | | | | |
| | G | | | | | | | | | | | | |

1. Add 2 ul VWR water to A5 well
2. Add 2 ul H11 tube to well A6
3. Add 2 and 20 ul amplified DNA to A and B wells
4. Make 2 mixes for 2 chips for A and B duplication:

5.

| | Mix 1: for 2 ul DNA | Mix 2: for 20 ul DNA |
|---|---|---|
| VWR water | 306 ul | 0 |
| T4 ligase buffer | 51 ul | 51 |
| T4 DNA ligase | 34 ul | 34 |

6. Add 5 ul of Vector to all wells
7. Add 23 ul of Mix #1 to 2 ul amplified DNA and Control wells (negative, positive and Transform) Note: Wells A1, A2, A5, A6, A7, B1, B2.
8. Add 5 ul of Mix #2 to 20 ul amplified DNA. Note: Wells A3, A4, B3, B4

9. Put PCR plate in thermo-cycle and run 16 C for 3 hr.

| For 2 ul amplified DNA | For 20 ul amplified DNA |
|---|---|
| 18 ul dH2O | No dH2O |
| 3 ul T4 ligase buffer | 3 ul T4 ligase buffer |
| 2 ul T4 DNA ligase | 2 ul T4 DNA ligase |
| 5 ul Vector | 5 ul Vector |
| 2 ul of amplified DNA | 20 ul of amplified DNA |

Note:
Amount of buffer/enzyme per ligated well

### Transformation

Material:
PCR plate
25 Bioassay
Nine 15 ml tubes
3 Petri dish
6 wells of cells
Ligated DNA
Transformation, H12
S.O.C

1. Add 50 ul of cells to PCR plate

2. Add 4 ul of ligated DNA to PCR plate

3. Add 4 ul of H12 to ‘Transform’ well

4. Seal and cover plate on ice for 30 minutes

5. Fill deep well (first 2 rows) with 350 ul of S.O.C

6. After 30 minutes, heat shock cells in water bath for 45 second at 42 C

7. Put on ice for 2 minutes

8. Transfer everything from PCR plate to deep well

9. Place on shaker for 1 hr at 225 rpm

10. Fill nine 15 ml tubes with 1400 ul S.O.C

11. Transfer each well from the deep well, except control wells (−, +, TR), to each tubes label according to the enzyme name (NgoIV or XmaI and DNA concentration (2 ul or 20 ul).

12. Split into 3 volumes (600 ul) and spread on three bioassays.

13. For controls, plate 71 ul

Materials and Methods

Ligation-mediated rolling circle amplification of in situ synthesized oligos

Ligation of in Situ Synthesized Oligos:

5′ phosphorylated in situ synthesized oligos were obtained from Atactic Technologies. Oligos were diluted in 0.3× Tag DNA ligase buffer (New England Biolab), heated at 95° C. for 5 minutes and cooled to 60° C. for 10 minutes. Additional Taq ligase buffer was added to final 1× Taq ligase buffer. 120 units of Taq ligase (New England Biolab) were added and the ligation was maintained at 60° C. for 3 hours. Optional: At the end of ligation, ligase can be removed by purification, e.g., Qiaquick nucleotide removal kit from Qiagen can be used.

Rolling Circle Amplification:

To 50 ul ligation, the following was added: 14 ul water, 5 ul 10× Phi29 buffer (NEB), 16 ul 2.5 mM dNTP, 5 ul 50 uM Primer S (TTTGAATTCthioGthioT) (SEQ ID NO: 8), 5 ul 50 uM Primer AS (TGTCTTCAthioTthioG) (SEQ ID NO: 9). The primers have thio modification in the last two bases. The mixture was heated at 95° C. for 5 minutes, 4° C. for 5 minutes and remained at 30° C. Then 40 units of Phi29 DNA polymerase (NEB) were added. 30 minutes after Phi29 addition, 2 ul reaction was taken out and the amount of double stranded DNA was measured with picogreen (Invitrogen) and a fluorescent reader at 15 minute intervals. When the double stranded DNA reached 150 ng/ul, the rolling circle amplification was terminated by heating at 65° C. for 20 minutes.

Restriction Digestion and Cloning

10 ul amplified DNA was digested by the combination of EcoRI and enzymes that generate compatible ends to AgeI digested DNA. Digested DNA was treated by shrimp alkaline phosphatase (USB) for 1 hour. The digestion was resolved on an 8% TAE polyacrylamide gel. Gel was stained with ethidium bromide. The band that corresponded to single hairpins was isolated. The gel piece was shredded. DNA was eluted with 100 ul 1× New England Biolab Buffer 2 overnight. 2 ul and 20 ul of eluted DNA were ligated into digested pLKO.1 vector. Colonies were picked and subjected to sequencing as described (Moffat, J., et al., Cell, 124:1283-1298 (March 2006).

DNA and Virus Production

Performed as described (Moffat, J., et al., Cell, 124:1283-1298 (March 2006).

Results

PCR amplification of in situ amplified oligos for shRNA library production

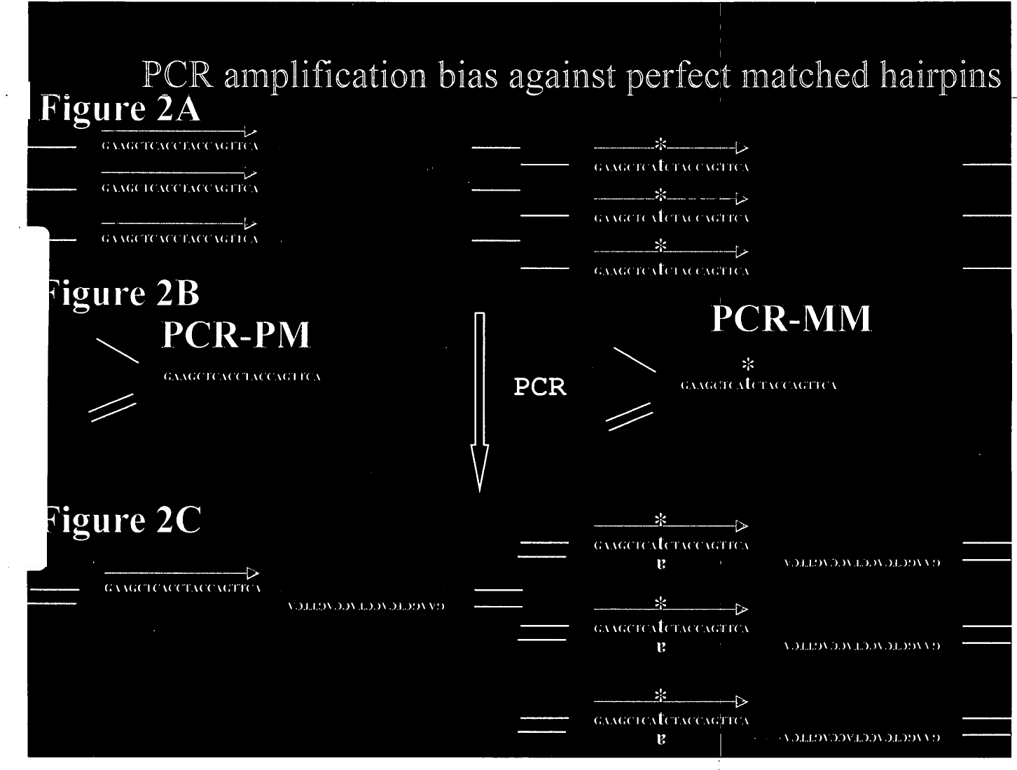

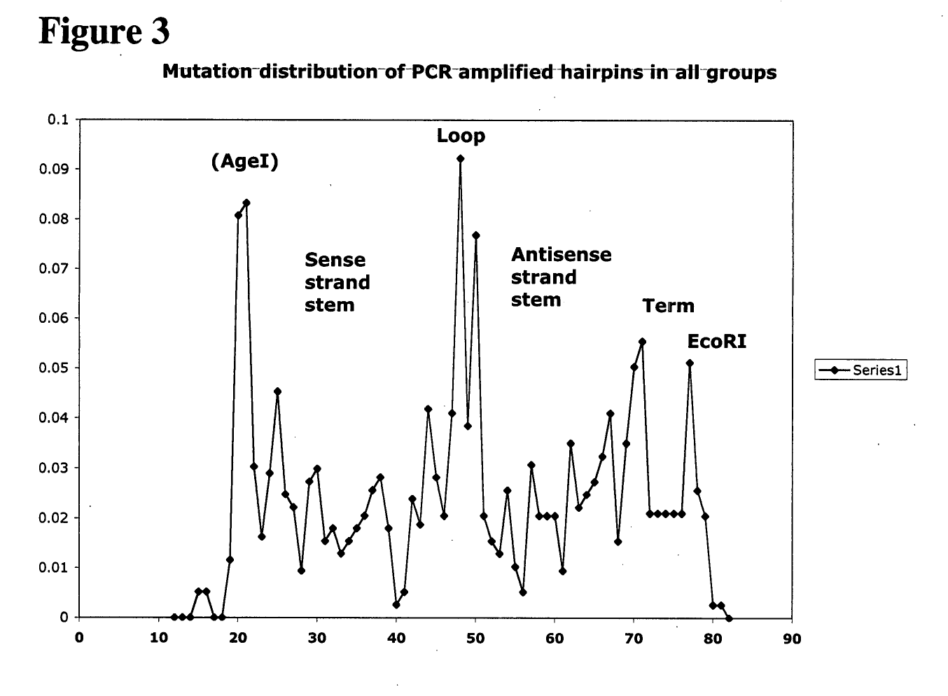

Described here are methods of producing shRNA libraries (e.g., genome wide shRNA libraries). Production of shRNA libraries from individually synthesized oligos is inefficient. Initially, in situ synthesized oligos to make shRNA libraries was attempeted (Cleary, Mass., et al., Nature Methods, 1:241-248 (2004)). During the chemical synthesis of in situ oligos, a mixture of oligos was synthesized for any given sequence. Due to the imperfections of chemical synthesis, mismatched bases or deletions occur at a certain rate for any given base. First, the baseline mutation rate from in situ synthesis was determined. Non-hairpin templates from Atactic Technologies were obtained, and the resulting constructs were PCR amplified, cloned and sequenced. From 795 bases sequenced, 18 bases did not match the input sequences. If the amplification did not introduce any additional mutations, the baseline mutation rate from synthesis alone was 2.2%. When hairpin sequences are synthesized, correctly synthesized sequences will have perfectly-matched stems of hairpins, resulting in a strong secondary structure that is difficult for DNA polymerase to amplify. On the other hand, some incorrectly synthesized sequences will create mismatches in the hairpin region. The inherently weaker secondary structures of the imperfect hairpins make them more amenable to amplification by PCR. Using a population of both perfectly base-paired hairpins and mutated hairpins containing mismatched bases, standard PCR amplification will preferentially amplify the mutated hairpins, resulting in an apparent mutation rate that is higher than the intrinsic mutation rate from synthesis (FIGS. 2A-2C). The mutation rate from synthesis was inferred to be 2.2%, based on sequencing of amplified non-hairpin sequences. When hairpin sequences were PCR amplified and sequenced, the apparent mutation rate in the hairpin region was 2.9% (FIG. 3), which is higher than the baseline mutation rate.

There are also size limitations to in situ synthesized oligos. Atactic Technologies can synthesize oligos up to 90 mers. The combination of the two stems of a hairpin, the loop, the terminator, and restriction enzyme sites can be about 66 bases. Typically, conventional PCR primers are at least 20 bases long, but the length of the amplification primers for in situ synthesized oligos are limited to 12 mers on each side. The amplification primers are also very close to the hairpins. The small size of the primers and their proximity to the hairpin contribute to inefficient and inconsistent PCR amplification.

To overcome the difficulties encountered in amplification, an error-correction, ligation-mediated rolling circle amplification (LM-RCA) method for high throughput production of shRNA libraries was developed. The hairpins' intrinsic tendency to self-anneal is transformed from a disadvantage in PCR amplification into an advantage in LM-RCA. By employing the new method described herein, the mutation rate was reduced, production efficiency was increased, and a robust and consistent production platform for high throughput production of shRNA libraries was engineered.

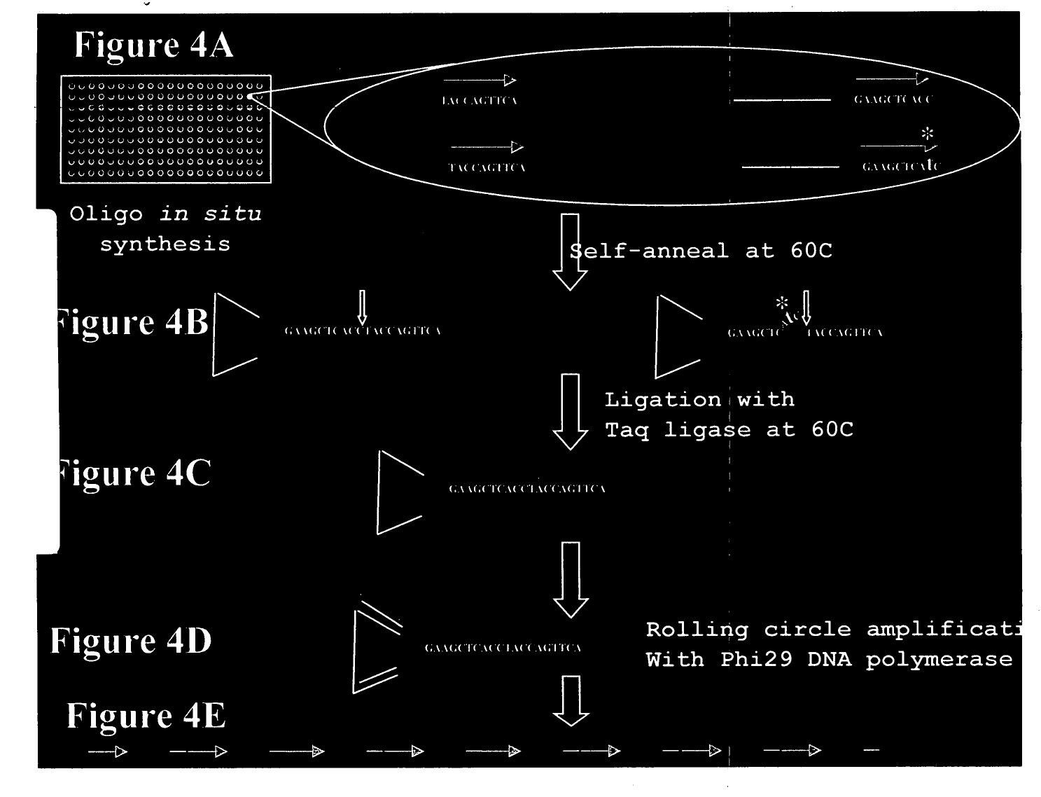

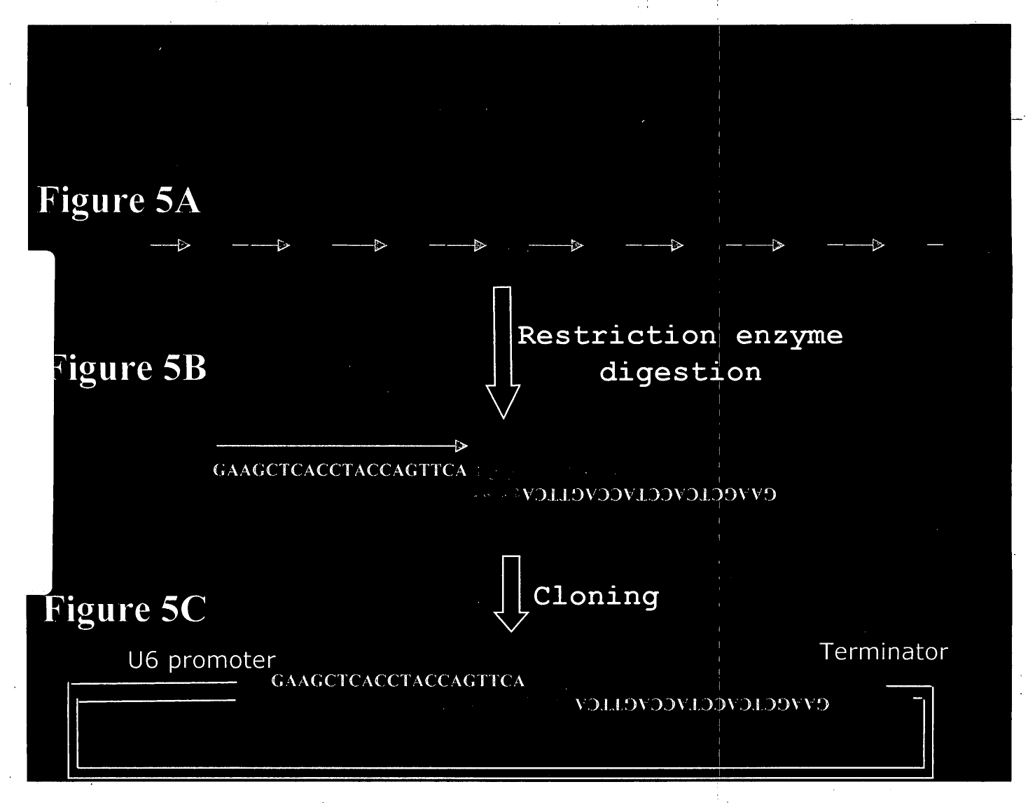

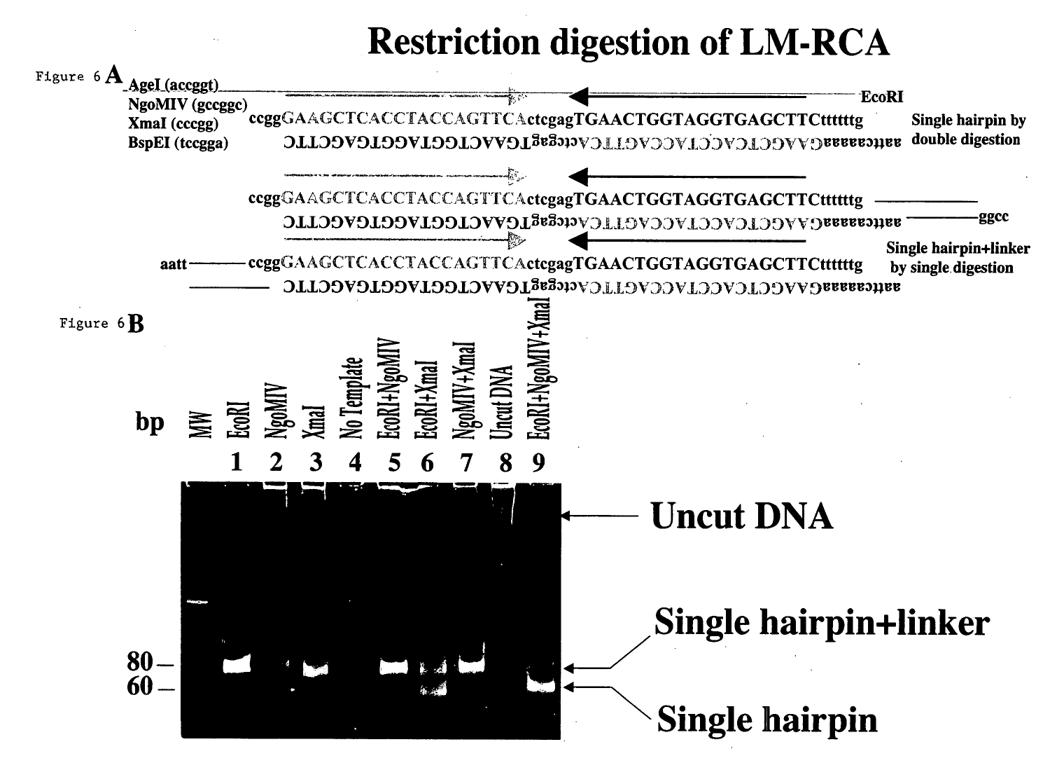

In the methods of the present invention, instead of synthesizing the stem-loop-stem of hairpins as an uninterrupted sequence, the oligo was synthesized starting with one part of the first stem, followed by the first loop, the complete second stem, the second loop, and finished with the remaining part of the first stem (FIG. 4A). The 5′ end of designed oligos can be phosphorylated during synthesis by using phosphorylated nucleotides at the 5′ base or by treating the oligos with kinases to add phosphate groups. Oligos were released from the chip by Atactic (Tian, J., et al., Nature, 432.1050-1054 (2004); Xiaochuan, Z., et al., Nucleic Acids Res., 32 (18):5409-5417 (2004)). The oligos were diluted in 0.3× of Taq DNA ligase buffer, denatured them at 95° C., and self-annealed under restrictive conditions (FIG. 4B). The two portions of the first stem annealed to the second stem, juxtaposing the phosphorylated 5′ end close to the 3′ end of the oligo. The annealing was perforrned under restrictive conditions. These conditions, which were maintained during the subsequent ligation of the ends of the oligo, selected for hairpins with perfectly base-paired stems. Mismatches in the hairpin region created by synthesis errors on either the first or second stem prevented hairpin formation under these restrictive conditions. Mismatches that were closer to the ends of the oligo had a greater effect in destabilizing the hairpin formation. After annealing, Taq DNA ligase was added to the annealed oligos in the presence of 1× Taq ligase buffer (FIG. 4C). The perfectly base-paired hairpins should have preferentially annealed, and ligated, creating closed circular DNA (FIG. 4C). The now circularized hairpin DNA served as templates for rolling circle amplification using a DNA polymerase with high processivity, such as Phi29 DNA polymerase (FIG. 4D). Two primers complementary to the two strands of the amplified double stranded circular DNA initiated the rolling circle amplification in the presence of Phi29 polymerase. The rolling circle amplification yielded double stranded strings of circularized hairpin sequences in a time-dependent fashion. These were subjected to restriction enzyme digestion to produce a double-stranded DNA fragment encoding a single hairpin (FIG. 5B). Uncut rolling circle amplified DNA had a high molecular weight (FIG. 6B, lane 8), which was consistent with the mechanism of RCA. All oligos had EcoRi sites downstream from the terminator. Single digestion with EcoRI created ˜80 bp fragments of single hairpins and linkers (FIG. 6B, lane 1). NgoMIV and XmaI can generate a 5′ overhang that is compatible with the overhang generated by AgeI digestion of the cloning vector, pLKO.1. A portion of oligos had NgoMIV sites upstream from the sense strand. Single digestion with NgoMIV created ˜80 bp fragments of single hairpins and linkers from a portion of amplified DNA, consistent with the presence of NgoMIV sites in a subset of the oligos (FIG. 6B, lane 2). Further NgoMIV digestion of the 80 bp fragment created by EcoRI reduced a portion of the DNA to ˜60 bp (FIG. 6 B, lane 5) of single hairpins, consistent with the presence of NgoMIV sites in a portion of the oligos. The portion of oligos that did not have NgoMIV sites had XmaI sites instead. Single digestion by XmaI and double digestion by EcoRI and XmaI were also consistent with predicted patterns (FIG. 6B, lanes 3 and 6). The single hairpin fragment was then cloned into an appropriately digested vector (e.g. pLKO.1) for shRNA expression (FIG. 5C).

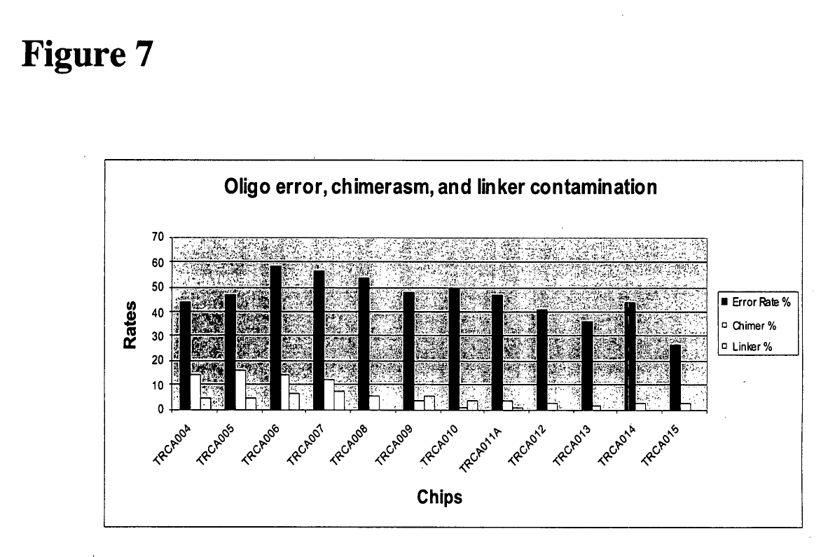

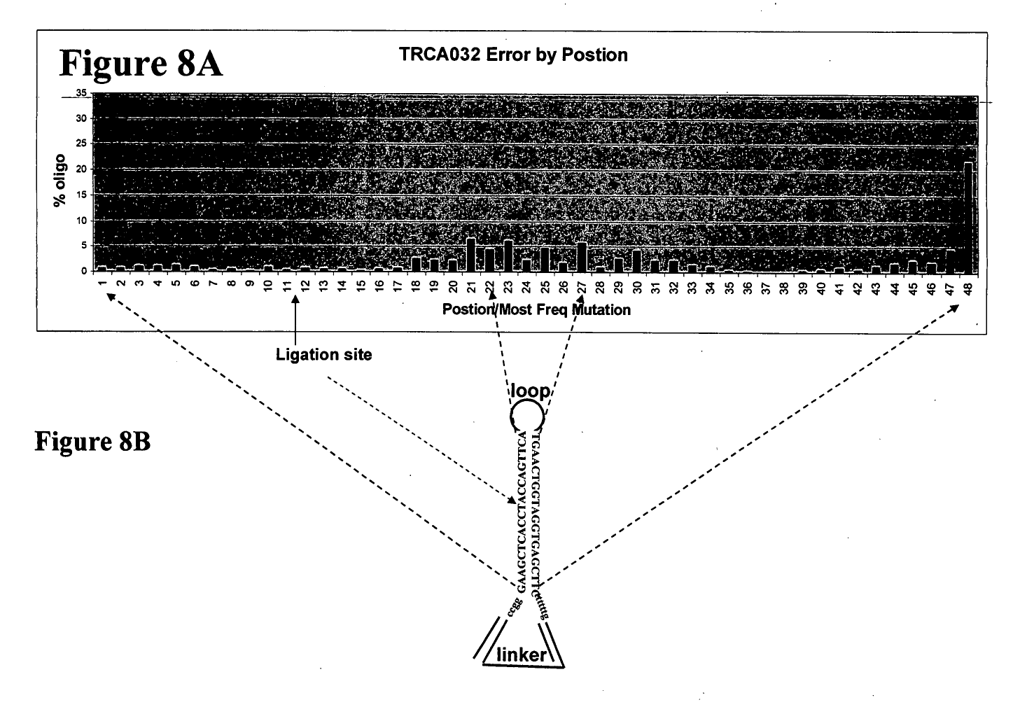

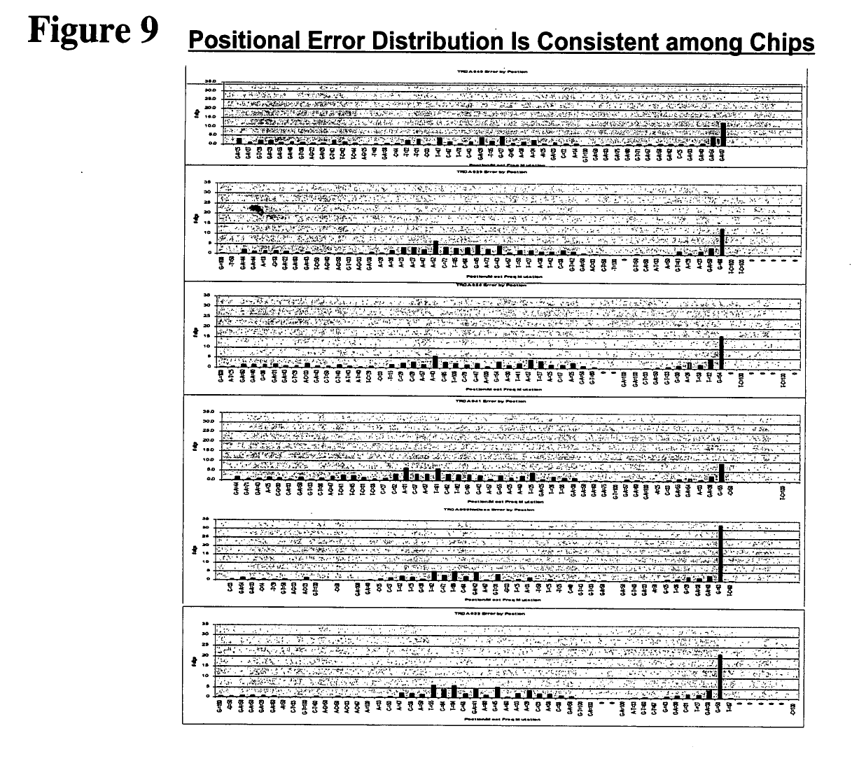

The mutation rate and mutation distribution of LM-RCA generated hairpin libraries were calculated. The effect of ligation-mediated error correction was evident, as the central portions of hairpin stem region had a significantly reduced mutation rate than the loop region and the ends of the hairpin stem (FIGS. 8A, 8B and 9), proving the prediction that LM-RCA reduces mutation rates, particularly in the central part of stems. The mutation rate from LM-RCA was calculated to be 1.3%, a 41% reduction from the 2.2% baseline synthesis mutation rate, and a 55% reduction from the 2.9% mutation rate of PCR amplified in situ oligos. Based on the 2.2%/base mutation rate during synthesis of 48 mer hairpins, the maximal representation of perfectly matched hairpins would be -34%. With the reduced mutation rate at 1.3%/base from LM-RCA, an average of 53% sequences perfectly matching intended sequences were obtained (FIG. 7).

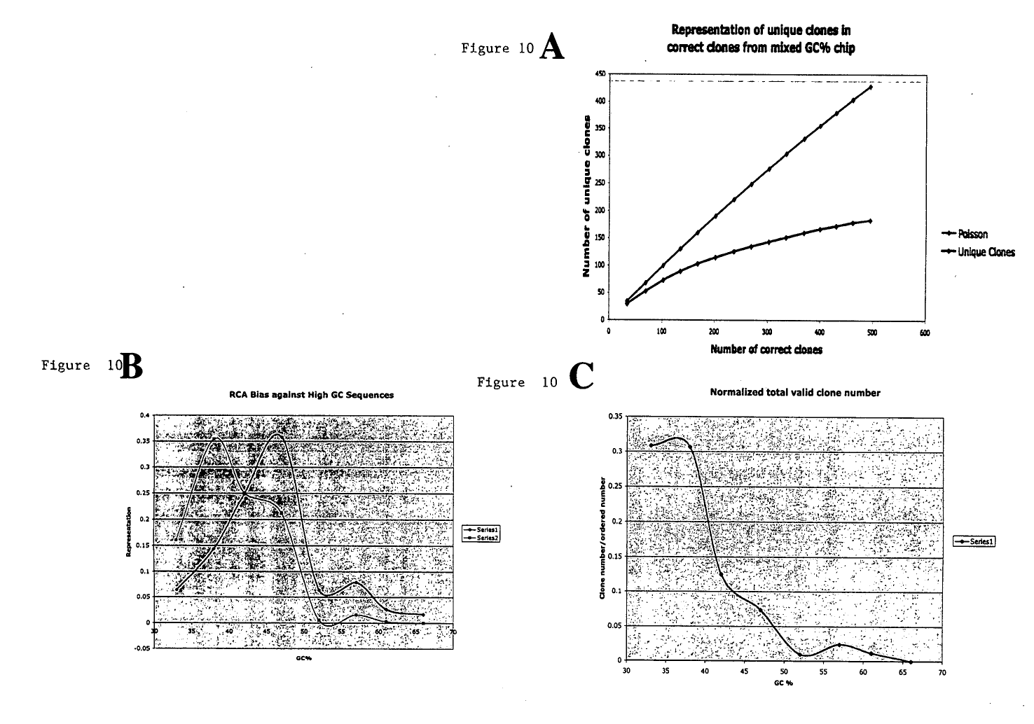

However, the unique clones produced from perfectly matched sequences were counted, a strong deviation from the distribution predicted was observed using a nonbiased random distribution represented by the simulated Poisson curve (FIG. 10A). From the experiments, some hairpins were sequenced multiple times while many others were not represented in the sequenced pools. When the clone representation according to various attributes of the hairpins was analyzed, a strong correlation between the clone abundance and GC % of hairpins was uncovered (FIGS. 10B, 10C). Low GC % sequences (e.g., about 30% to about 50% GC %; sequences having low thermostability) were preferentially amplified and over-represented, while amplification of high GC % sequences (e.g., about 50% to about 70% GC %; sequences having high thermostability) was relatively inefficient, resulting in reduced representation. This can be explained by the stronger secondary structures of GC-rich hairpins, which can inhibit amplification.

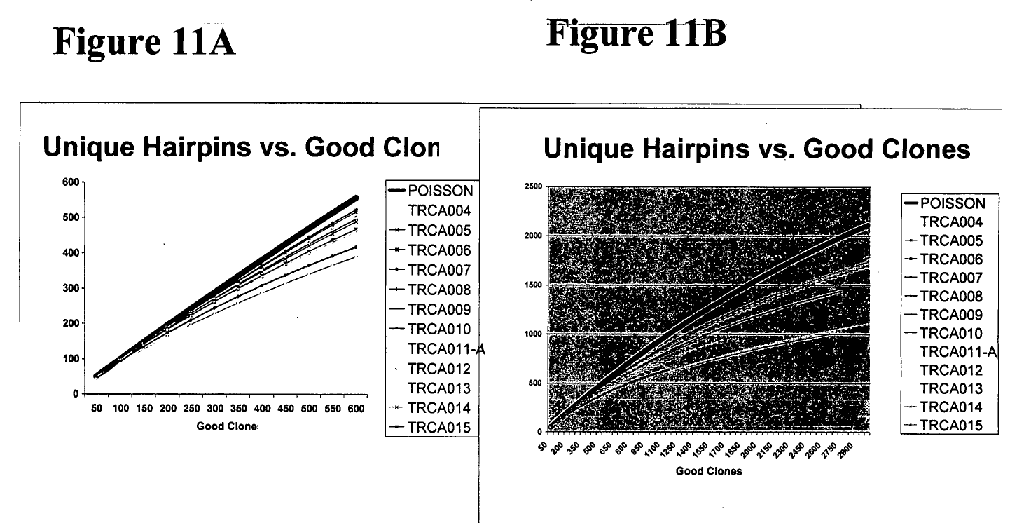

To obtain a more even clone distribution, the hairpins were separated according to their GC % and amplified separately. The method significantly reduced the representation bias, leading to a much more even hairpin distribution for a given amplification (FIGS. 11A, 11B). FIG. 10A and FIG. 11A show results from a comparable level of sequencing for mixed GC amplification and GC-segregated amplification, respectively. Significant numbers of unique clones were produced from GC-segregated amplification. The libraries continued to yield substantial numbers of clones when deep sequencing was performed (FIG. 11B).

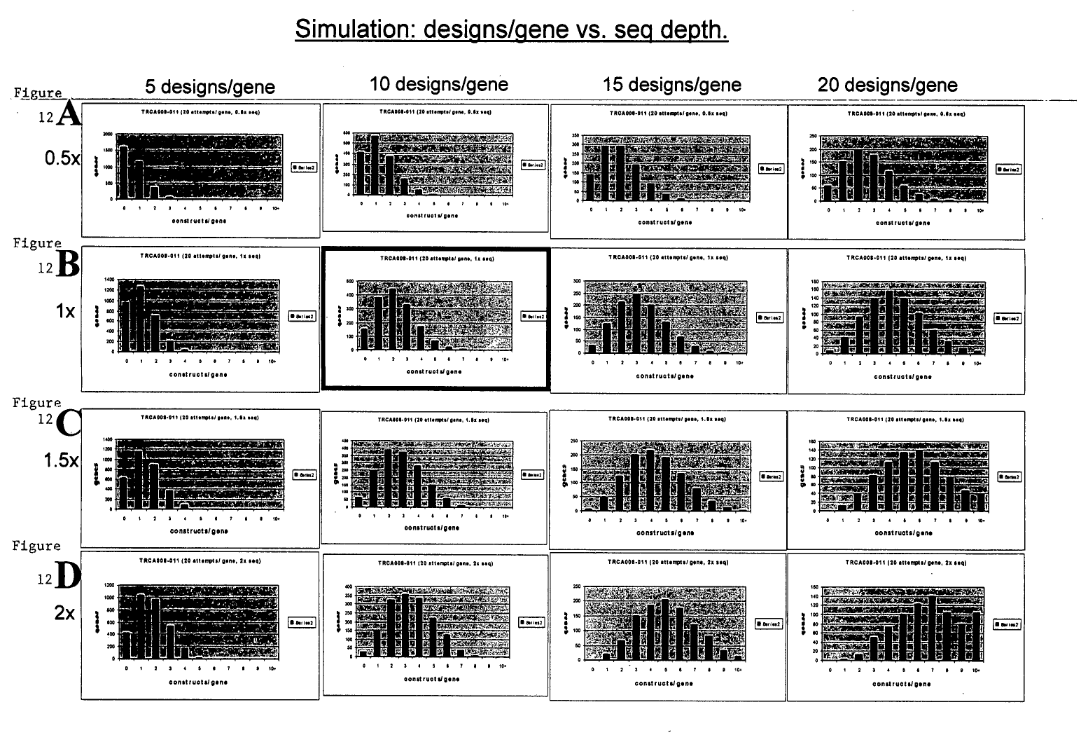

For the construction of shRNA libraries, usually a certain number of constructs are desired to target any given gene. Because of the high complexity of in situ synthesized oligos, the chance of recovery for any given hairpin through limited sequencing is significantly less than 100%. To empirically determine the optimal approach in producing shRNA libraries, extensive sequencing of shRNA libraries produced from one set of chips was performed. The data was used to simulate the results obtained if the following two variables were changed: the number of constructs/gene and sequencing depth (FIG. 12). From this data set, optimal numbers of constructs/gene and sequencing depth can be decided, according to the production requirement of the libraries.

For our current libraries, 5 constructs/gene within a fixed time frame can be produced. Ten (10) constructs/gene and 1× sequencing depth were chosen for the current production. The genes with fewer than 5 constructs after one production cycle were identified. These genes entered the next production cycle for the creation of additional constructs.

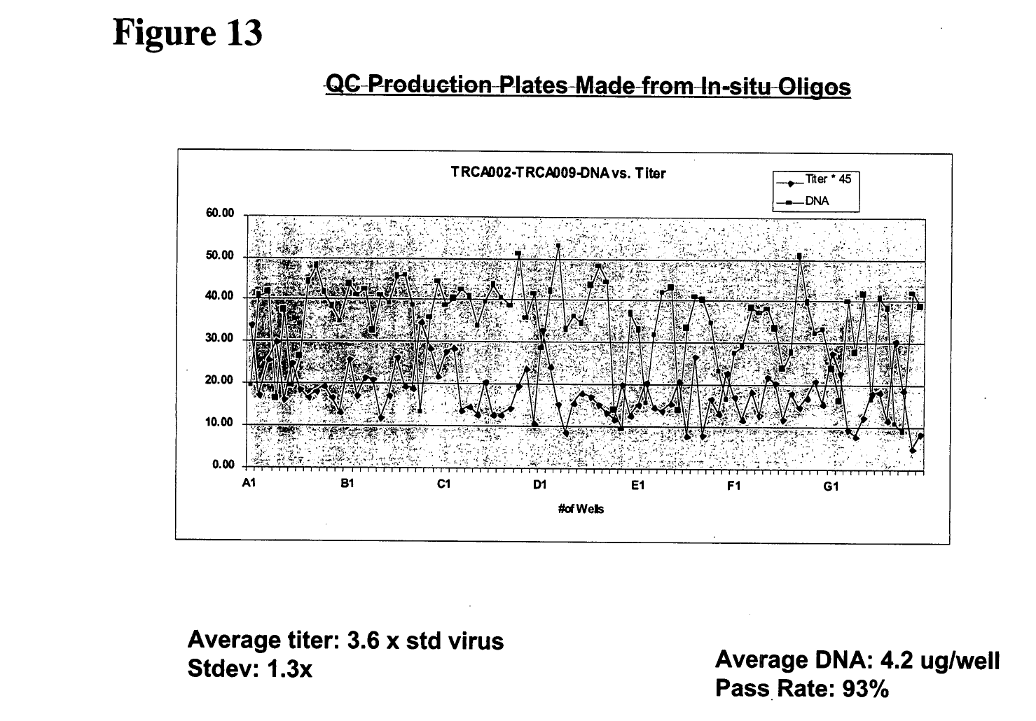

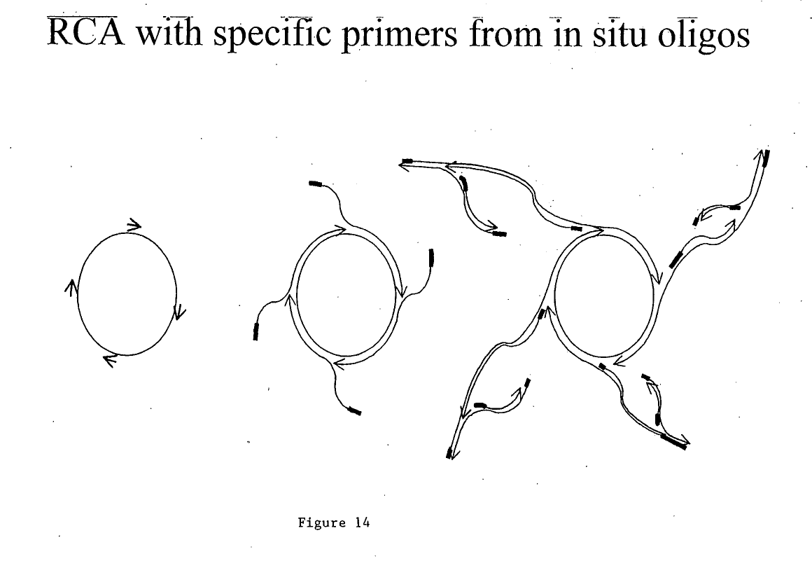

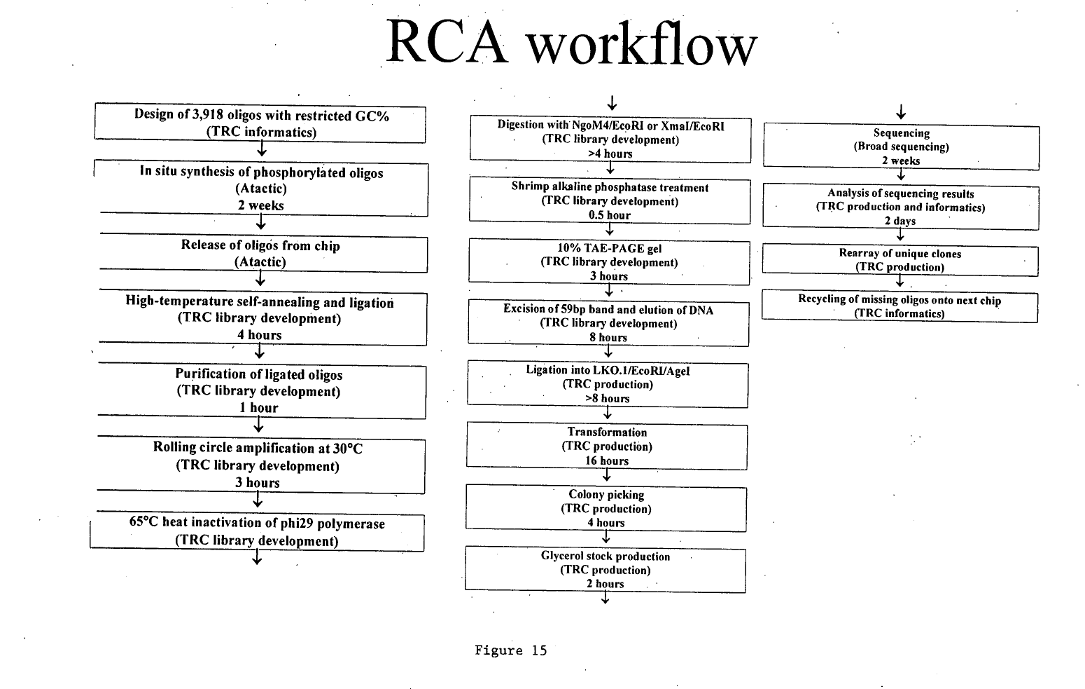

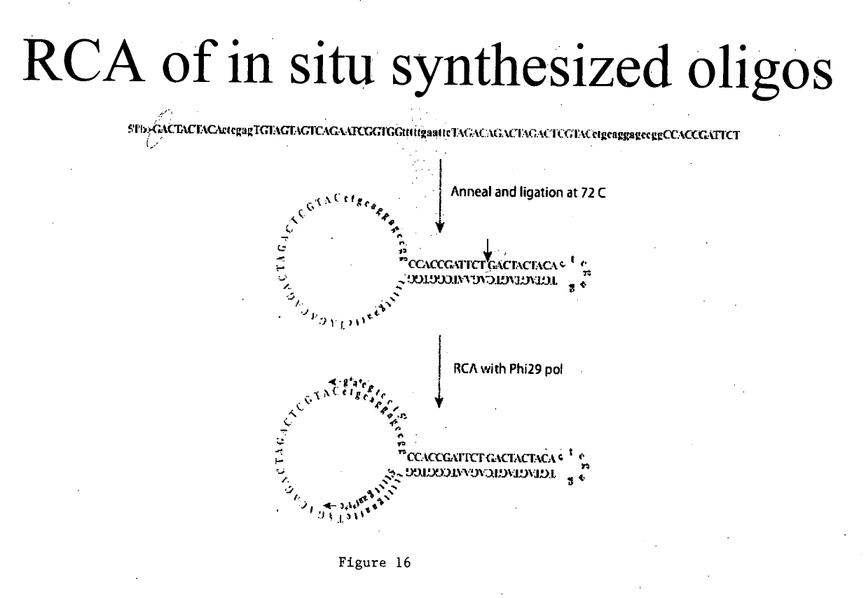

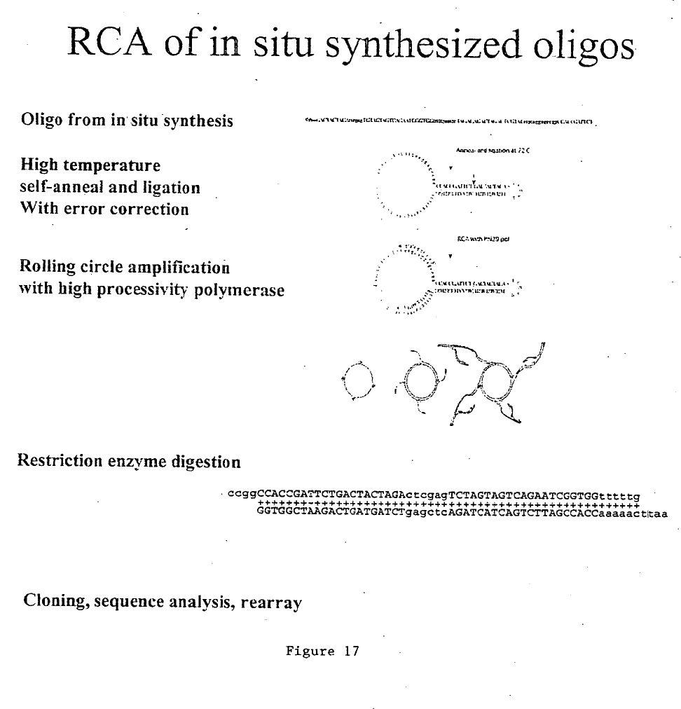

Though a fundamentally different approach to clone in situ synthesized oligos for hairpin libraries than conventional methods using individually synthesized oligos or PCR amplification was used, differences between the clones with respect to downstream applications were not observed. The clones produced with LM-RCA were stable. The DNA yield and viral yield when used for virus production were comparable to those from clones produced from individually synthesized oligos (FIG. 13).

Another advantage is that rolling circle amplification requires much smaller primer binding sites than PCR. It is possible to synthesize unique, designed molecular barcode sequences (Westbrook, T F, et al., Cell, 121:837-848 (2005); Ngol, V N, et al., Nature 441:106-110 (2006)) that are covalently linked to hairpin sequences for high throughput screens using barcoded libraries. Alternatively, one or more restriction enzyme sites can be embedded in one of the loop (e.g., the first loop). For high throughput pooled screens, the hairpins can be amplified and digested with the corresponding restriction enzyme to digest the loop. The two stems are physically separated and can be used as accurate molecular barcodes for hybridization to microarrays.

Using the methods described herein, the mutation rate throughout LM-RCA has been significantly reduced. Mutation hot spots of cloned sequences, including two ends of stems, can still exist. Conversion of single stranded DNA circle with significant hairpins into double stranded DNA circle would likely increase the supercoils of this relatively small circle. The increased supercoils can inhibit DNA amplification by DNA polymerase. Supercoils in LM-RCA can be reduced using known agents such as topoisomerase. In addition, single stranded DNA binding protein in LM-RCA.

The teachings of all references, patents and patent applications cited herein are incorporated herein by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of producing a short hairpin library comprising:
a) obtaining single stranded short hairpins wherein each single stranded short hairpin sequence has a 5′ to 3′ order comprising:
a first portion of a first strand of a stem of the hairpin
a first loop of the hairpin—a second strand of the stem
of the hairpin—a second loop—a second portion of the
first strand of the stem of the hairpin;
wherein the sequence of the first strand of the stem of the hairpin and the sequence of the second strand of the stem of the hairpin are complementary;
b) maintaining the single stranded hairpins of a) under conditions in which each single stranded hairpin self anneals, wherein the first strand of the stem hybridizes to the second strand of the stem thereby forming a double stranded stem, and wherein the double stranded stem is flanked by the first loop and the second loop, thereby converting each single stranded hairpin into a circularized hairpin which results in the formation of a plurality of circularized hairpins;
c) ligating the ends of the circularized hairpins of b);
d) combining the circularized hairpins of c) with dNTPs, a polymerase and primers, thereby producing a combination; and
e) maintaining the combination of d) under conditions in which rolling circle amplification of the circularized hairpins occur and a plurality of double stranded concatemers are produced, wherein each double stranded concatemer comprises multiple copies of a short hairpin linked end to end;
thereby producing a short hairpin library.

2. The method of claim 1 further comprising:
f) digesting the double stranded concatemers of e), thereby generating individual double stranded hairpins.

3. The method of claim 2 further comprising:
g) cloning the individual double stranded hairpins into one or more vectors.

4. The method of claim 3 further comprising:
h) maintaining the one or more vectors of g) under conditions in which the individual double stranded hairpins are expressed.

5. The method of claim 1 wherein the single stranded hairpins of step a) are obtained by synthesizing the single stranded hairpins on a chip and the single stranded hairpins are removed from the chip prior to step b).

6. The method of claim 1 wherein the first strand of the stem of the hairpin is the sense strand.

7. The method of claim 1 wherein the first strand of the stem of the hairpin is the antisense strand.

8. The method of claim 1 wherein the first loop is the loop region of the hairpin and comprises a sequence of about 6 nucleotides.

9. The method of claim 1 wherein the second loop circularizes the hairpin and comprises a sequence of about 24 nucleotides.

10. The method of claim 9 wherein the sequence of the second loop includes restriction endonuclease recognition sites.

11. The method of claim 1 wherein the conditions in which each single stranded hairpin self anneals in step b) comprises maintaining the hairpins at about 60° C.

12. The method of claim 1 wherein the ends of the circularized hairpins in step c) are ligated by combining the circularized hairpins with at least one ligase.

13. The method of claim 12 wherein the ligase is a Taq ligase.

14. The method of claim 13 wherein the method further comprises maintaining the hairpins of step c) at 60° C.

15. The method of claim 1 wherein the dNTPs of step d) are labeled.

16. The method of claim 1 wherein the polymerase of step d) is Phi29.

17. The method of claim 1 wherein the sequences of the primers of step d) comprise from about 9 to about 10 nucleotides.

18. The method of claim 1 wherein the conditions in which rolling circular amplification of the hairpins occur in step e) comprise combining the circularized hairpins with dNTPs, a phi29 DNA polymerase and primers that are complementary to the sense strand of the circularized hairpins and primers that are complementary to the antisense strand of the circularized hairpins.

19. The method of claim 1 wherein the vector is a lentiviral vector.

20. The method of claim 16 wherein the lentiviral vector is an LKO.1 vector.

21. The method of claim 1 wherein the vector comprises a U6 promoter and a terminator sequence.

22. The method of claim 1 wherein the short hairpins comprise identical or substantially similar GC %.

23. A method of producing a short hairpin RNA (shRNA) library comprising:
a) obtaining single stranded short hairpin DNAs (shDNAs) wherein each single stranded short hairpin DNA (shDNA) sequence has a 5′ to 3′ order comprising:
a first portion of a first strand of a stem of the shDNA
a first loop of the shDNA—a second strand of the stem
of the shDNA—a second loop—a second portion of the
first strand of the stem of the shDNA;
wherein the sequence of the first strand of the stem of the shDNA and the sequence of the second strand of the stem of the shDNA are complementary;
b) maintaining the single stranded shDNAs of a) at about 60° C. for about 10 minutes wherein the single stranded shDNAs self anneal, whereby the first strand of the stem hybridizes to the second strand of the stem forming a double stranded stem, and wherein the double stranded stem is flanked by the first loop and the second loop, thereby converting each single stranded shDNA into a circularized shDNA which results in the formation of a plurality of circularized shDNAs;
c) combining the circularized shDNAs of b) with Taq ligase at 60° C. for about 3 hours to ligate the circularized shDNAs;
d) combining the circularized shDNAs of c) with dNTPs, a phi29 DNA polymerase and primers that are complementary to the sense strand of the circularized shDNAs and primers that are complementary to the antisense strand of the circularized shDNAs, thereby producing a combination;
e) maintaining the combination of d) under conditions in which rolling circle amplification of the circularized hairpins occur and a plurality of double stranded concatemers are produced, wherein each double stranded concatemer comprises multiple copies of a shDNA linked end to end,
thereby producing a shRNA library.

24. The method of claim 23 further comprising:
f) digesting the double stranded concatemers of e), thereby generating individual double stranded shDNAs.

25. The method of claim 24 further comprising:
g) cloning the individual double stranded shDNAs into one or more vectors.

26. The method of claim 25 further comprising:
h) maintaining the one or more vectors of g) under conditions in which the individual double stranded shDNAs are expressed.

27. The method of claim 23 wherein the single stranded shDNAs of step a) are obtained by synthesizing the single stranded shDNAs on a chip and the single stranded shDNA are removed from the chip prior to step b).

28. The method of claim 23 wherein the first strand of the stem of the shDNA is the sense strand.

29. The method of claim 23 wherein the first strand of the stem of the shDNA is the antisense strand.

30. The method of claim 23 wherein the first loop is the loop region of the hairpin and comprises a sequence of about 6 nucleotides.

31. The method of claim 23 wherein the second loop circularizes the hairpin and comprises a sequence of about 24 nucleotides.

32. The method of claim 31 wherein the sequence of the second loop includes restriction endonuclease recognition sites.

33. The method of claim 23 wherein the dNTPs of step d) are labeled.

34. The method of claim 23 wherein the sequences of the primers of step d) comprise from about 9 to about 10 nucleotides.

35. The method of claim 23 wherein the vector is a lentiviral vector.

36. The method of claim 35 wherein the lentiviral vector is an LKO. 1 vector.

37. The method of claim 23 wherein the vector comprises a U6 promoter and a terminator sequence.

38. The method of claim 23 wherein the short hairpins comprise identical or substantially similar GC %.
